(19) United States
(12) Patent Application Publication
(10) Pub. No.: US 2016/0177822 A1
(43) Pub. Date: Jun. 23, 2016

(54) Hybrid Power Generation System

(71) Applicant: ISENTROPIC LTD, Fareham, Hampshire (GB)

(72) Inventors: Jonathan Sebastian Howes, Hampshire (GB); James Macnaghten, Hampshire (GB)

(21) Appl. No.: 14/910,153

(22) PCT Filed: Aug. 7, 2014
(86) PCT No.: PCT/GB2014/052419

§ 371 Date: Feb. 4, 2016

(30) Foreign Application Priority Data
Aug. 7, 2013 (GB) 1314151.0
Jun. 6, 2014 (GB) 1410083.8

(51) Int. Cl. F02C 6/08; F02C 7/057; F01D 15/10; F02C 3/04

(52) U.S. Cl. CPC F02C 6/08; F02C 3/04; F02C 7/057; F01D 15/10; F05D 2220/32; F05D 2240/35; F05D 2260/42

(57) ABSTRACT

A system includes a primary, combustion turbine based system that includes one or more power shaft assemblies including a generator or motor/generator, a compressor and an expansion turbine associated with the one or more power shaft assemblies, and a combustor to feed the expansion turbine. The primary system includes a first flow network allowing outlet air from the compressor to pass downstream to the combustor for combustion and the expansion turbine for expansion. The primary system is modified by integration of an adiabatic compressed air energy storage sub-system that includes a compressed air store and a thermal energy storage system for removing and returning thermal energy to the compressed air upon charging and discharging the store. The sub-system includes a second flow network allowing outlet air from the compressor to pass, upon charging, to the compressed air store, and to pass, upon discharging, back to the combustor and/or expansion turbine.

### FIELD OF THE INVENTION

The present invention relates to a hybrid power generation system, the use of apparatus in such a system, and methods for constructing and operating such a system; in particular, the invention relates to a hybrid combustion turbine power generation system with inbuilt energy storage for flexible load management during power generation.

### BACKGROUND TO THE INVENTION

About one-quarter of the world's electricity generation is based on natural gas. There are two main types of gas-fired power plants: open cycle gas turbine (OCGT) plants, and combined cycle gas turbine (CCGT) plants. A normal open cycle gas turbine plant (OCGT) generates power by air in a compressor, adding and then combusting the natural gas to add heat in a combustion chamber, followed by expansion of the hot high pressure gas back to atmospheric pressure in a gas turbine. The compression process in an industrial gas turbine normally raises the temperature of the air to between 450 and 600° C. and to a pressure of around 18 bar. The combustor raises this pressurised gas to a much higher compressing temperature, say 1400° C. turbine inlet temperature, before it is expanded through the turbine and then exhausted. The exhaust gas from a OCGT plant is normally at a temperature of 400 or 500 degrees centigrade and is discharged into the atmosphere. The compressor and gas turbine are aligned on a single shaft connected to an electricity generator and almost half of the gross power output of the gas turbine is used by the compressor to compress the gas, with the remainder driving the electricity generator. This cycle generates power for a very low capital cost and is very compact; however the electrical efficiency of OCGT's tends to be quite low, normally in the range of 33% and 40%. As a result, OCGT's are often built as peaking plant to cover peak periods. This means that the normal utilization can be around 5% or 400 hours per annum.

In the 1990's a more efficient form of gas powered generation, called a combined cycle gas turbine (CCGT) plant, was introduced, which additionally include a steam turbine bottoming cycle. A heat recovery steam generator (HRSG) is added to the hot gas turbine exhaust to generate steam in a steam cycle so as to drive a steam-turbine generator and produce additional power. In a CCGT plant, about two-thirds of the total power is generated by the gas turbine, and one-third by the steam turbine. A modern CCGT can now achieve an efficiency of 60%, is easily ramped up and down, and is used for both base-load (>5000 hrs/yr) and intermediate load (2000 to 5000 hrs/yr) electricity generation, often for 60-80% of the day.

The proliferation of renewable generation technology such as wind turbines has driven interest in developing new methods of energy storage. The most prolific current technology is pumped hydro and then, at a much smaller scale, Compressed Air Energy Storage (CAES).

A number of different methods of compressed air energy storage have been proposed including Diabatic CAES (DCAES), Adiabatic CAES (ACAES) and Isothermal CAES (ICAES). All of the systems have only medium round trip efficiencies in the region of 40-70%. Normal CAES systems operate at much higher pressures than CCGT's or OCGT's. For example, modern OCGT's and CCGT's operate with GT combustion pressures between about 15 to 23 bar. In comparison, a CAES system might operate from 60-80 bar for Adiabatic CAES, 100-120 bar for Diabatic CAES and as high as 200 bar for Isothermal CAES. There are a number of reasons why CAES systems operate at higher pressures: it is, for example, safer to cycle salt caverns over a small pressure range at very high pressures. Since they are designed around much higher pressures than CCGT's and OCGT's, most proposed CAES systems suffer from high capital costs for the power equipment and poor round trip efficiencies.

CAES systems utilizing thermal energy storage (TES) apparatus to store heat have been known since the 1980's. In particular, ACAES systems store the heat of compression of the compressed air in thermal stores for subsequent return to the air as it leaves a compressed air store before undergoing expansion. The TES apparatus may contain a thermal storage medium through which the compressed air passes, releasing heat to the storage medium, thereby heating the store and cooling the air. The thermal storage medium may be in the form of a porous storage mass, which may be a packed bed of solid particles through which the air passes exchanging thermal energy directly, or, it may comprise a solid matrix or monolith provided with HTF channels or interconnecting pores extending therethrough, or, the fluid may pass through a network of heat exchange pipes that separate it from the storage mass, such as a packed bed of particles (e.g. rocks). Alternatively, the compressed air may pass through a heat exchanger that is coupled to a separate thermal store, such that heat is transferred indirectly to the latter via a heat transfer fluid, in which case the thermal store need not be pressurised and could include a thermal storage medium such as a molten salt or high temperature oil.

It should be noted that while many systems for ACAES have been proposed, none have yet been built, mainly because it is difficult to deal with both high temperatures and high pressures. For high temperatures it is preferable to use sensible heat exchange to a solid as it is hard to find candidate liquids that can cover the temperature range of ambient to 500° C. without requiring very high pressures to contain them. However, if thermal exchange is to be direct to the storage medium it is then necessary to contain the pressure. For a TES to be used with a cavern means that it will be a large system that must process large quantities of air. This implies that the TES needs to be quite large; however, there are significant structural and thermal issues with building large pressurised structures to contain hot materials.

When transferring heat to the TES it is preferable that the flow rate of the compressed air is not too fast so as to allow efficient thermal exchange and avoid undesirable pressure drops.

Applicant's earlier application WO2011/104556 describes a thermal store in which the size and type of media can be varied through the store to either reduce the irreversibilities that are created when a thermal front is generated or else to help reduce the pressure drop that develops across the store. This application also proposes a thermal storage system with a high pressure store for storing high temperature heat, wherein the high pressure store is selectively coupled and decoupled to a lower pressure store such that lower pressure gas may be circulated between the two stores so as to relocate the heat in a lower pressure (and hence lower cost) store.

Applicant's earlier application WO2012/127178 proposes TES apparatus wherein the storage media is divided up into separate respective downstream sections or layers. The flow path of the heat transfer fluid through the layers can be selectively altered using valving in the layers so as to access only certain layers at selected times, so as to avoid pressure losses through inactive sections upstream or downstream of the sections where the thermal front is located and to maximise store utilisation. TES apparatus incorporating layered storage controlled by valves (more particularly, direct transfer, sensible heat stores incorporating a solid thermal storage medium disposed in respective, downstream, individually access controlled layers) can provide very efficient storage of heat up to temperatures of 600° C. or even hotter. It should be noted that the flow velocity through such a bed may be as low as 0.5 m/s or even lower.

U.S. Pat. No. 5,778,675 describes a hybrid combustion turbine derivative power generation system sized for base load operation that is also capable of providing short-duration intermediate load or peak load power by using stored compressed air previously compressed by the gas turbine's compressor. The hybrid system may employ a variety of combustion turbine thermal cycles, including a simple cycle combustion turbine plant, combustion turbine plants with intercooling, reheat, recuperation, steam injection and humidification, and combined cycle power plants. This system can only generate power by combusting natural gas (or fuel oils) and involves multiple, different pressure compressor/expander stages, combustor stages, and heat recovery measures in order to integrate a compressed air storage system designed for storage of ambient, high pressure gas.

The present invention is directed towards providing an improved hybrid combustion turbine power generation system.

### SUMMARY OF THE INVENTION

In accordance with a first aspect of the present invention, there is provided a hybrid combustion turbine power generation system (CTPGS) comprising:

a primary, combustion turbine based system,

the primary system comprising one or more power shaft assemblies comprising at least a first generator or motor/generator, at least a first compressor and at least a first expansion turbine operatively associated with the one or more power shaft assemblies, and at least one combustor configured to feed the at least first expansion turbine,

wherein the primary system comprises a first flow network allowing outlet air from the at least first compressor to pass successively downstream to the at least one combustor for combustion and the at least first expansion turbine for expansion, respectively,

wherein the primary system is modified by integration of:

an adiabatic compressed air energy storage (ACAES) sub-system,

the sub-system comprising at least one compressed air store and at least a first thermal energy storage (TES) system for removing and returning thermal energy to the compressed air upon charging and discharging the store, respectively,

wherein the sub-system comprises a second flow network allowing outlet air from the first compressor to pass, upon charging, via the TES system to the at least one compressed air store, and to pass, upon discharging, back to the at least one combustor and/or first expansion turbine, via the TES system,

wherein the hybrid CTPGS further comprises flow valve arrangements and mechanical coupling arrangements so configured as to provide the necessary flow and mechanistic connections to allow the hybrid CTPGS to be operable in at least the following modes of operation:—

(i) a power generating first mode in which the hybrid CTPGS produces power and the sub-system is not discharging; and,

(ii) a power generating second mode in which the hybrid CTPGS produces power and the sub-system is discharging.

The present invention provides a hybrid CTPGS based on a combustion turbine system but with an integrated energy storage system involving both thermal energy storage and compressed air storage (i.e. ACAES).

The primary system, based on a typical combustion turbine power generation system, is operable in a power generating first mode to supply power (i.e. self-sufficiently) using the first flow network (which would not include any compressed air storage). However, a secondary or sub-system including some energy storage capability is integrated into the CTPGS such that the sub-system shares some of the primary system components (e.g. sharing the said first compressor and said first expansion turbine) and is operable simultaneously with the primary system to provide a power generating second mode (e.g. for enhanced power generation).

The primary, combustion turbine based system will usually be sized for intermediate load (2000 to 5000 hrs/yr) electricity generation (or about 6 to 14 hours/day), such that the sub-system can be charged during the non-generating window of the CTPGS. The sub-system may be selectively configured to assist with intermediate load and/or peak load electricity generation.

The generator will be connectable or connected to other equipment, or to a local or national grid to supply electricity (eg. via a transformer).

The CTPGS may be an OCGT plant, or CCGT plant, or other derivative combustion turbine plant.

The CTPGS is a power plant based on a combustion turbine and this may be a simple cycle SCOT/open cycle OCGT, with only one power cycle and no provision for waste heat recovery, or it may be any known or suitable future variant or derivative thereof (e.g. where the power cycle is augmented or supplemented by further cycles or measures for improved power generation) but which could still benefit from integration of a secondary, energy storage system. This will commonly be a combined cycle gas turbine CCGT (i.e. with a steam turbine bottoming cycle in addition to the topping cycle), or a variant thereof, for example, a CTPGS with intercooling, reheat, recuperation, or with steam injection.

It is preferable for the hybrid CTPGS to be able to start-up in a normal gas turbine mode, for example, using known practices, prior to any active charging or discharging of the sub-system occurring.

In the power generating first mode (i), the hybrid CTPGS produces power and the sub-system is not discharging i.e. no air is being recovered from air storage, although the sub-system may be storing air and heat in the respective stores. The at least one combustion turbine uses fuel (e.g. natural gas) to produce power, which is used internally to drive the first compressor on the power shaft assembly to produce the compressed air. The valves are configured to divert some or all of the compressed air (depending on the sub-mode) towards the combustor and turbine. In the latter case, which may be regarded as the “normal operation sub-mode”, and is likely to be the most common mode of running, the hybrid CTPGS acts like a normal combustion turbine based power station (e.g. OCGT, CCGT or other derivative).

The hybrid may be operable in a sub-mode of the power generating first mode in which the sub-system is also not charging and all of the compressed air from the first compressor is directed towards the combustor and expansion turbine.

The hybrid CTPGS may be operable in a further sub-mode of the power generating first mode in which the sub-system is self-charging such that some of the compressed air from the first compressor is directed towards the sub-system and some is directed towards the combustor and expansion turbine (for power generation). Rather than all the air passing through to the turbine, in this “self-charging sub-mode”, the valves may be configured to divert a proportion (usually no more than 40%, preferably no more than 20%) of the air towards the sub-system.

The hybrid may be operable in a charging-only (i.e. non-generating) third mode in which the expansion turbine is inactive and the first compressor is electrically driven by the motor/generator, or a separate motor, to charge the sub-system, all of the compressed air from the compressor being directed towards the sub-system.

Preferably, a combined first motor/generator acting as a motor, may drive the first compressor on a power shaft assembly to produce the compressed air using electrical power, usually from an electric grid, in a period when the hybrid CTPGS is not required for power generation and the turbine is inactive (and uncoupled e.g. de-clutched from the power shaft assembly), usually in an off-peak period when the electricity is cheaper. The valves are configured to divert the compressed air solely towards the TES and downstream air storage. Alternatively, one power shaft assembly may only include a generator, in which case a separate dedicated motor/power shaft for charging the compressor may be additionally provided (e.g. on its opposite side) that can be coupled to it, for example, by a clutch connection to the compressor and/or first power shaft assembly.

In the case of a multiple unit CTPGS installation, instead of using electrical power from a local grid to drive the motor, it may be more economically desirable for at least one CTPGS unit to be designated to generate electrical power that is used to drive the above-mentioned motor or motor/generator acting as a motor of the first unit. Hence, in the hybrid CTPGS, the sub-system may be charged using electricity and/or may be self-charged (i.e. fuel-fed).

In the power generating second mode, the sub-system is acting in a discharge mode such that some or all of the hot high pressure air is supplied from the at least one compressed air store/TES. Thus, the at least one combustion turbine still uses fuel (e.g. natural gas) to produce power, but the at least one compressor (which draws power), may be stopped (for maximum power generation) or its capacity reduced, such that some or all of the hot high pressure air is supplied from the air store/TES. The valves are configured to divert any compressed air from the compressor solely towards the combustor and turbine, and to direct all the hot high pressure air returning from the air store/TES towards the combustor and turbine. In this mode, if the compressor is not supplying any air then one option is for the valve to act as a non-return valve so air from the air store cannot exit through the compressor in the reverse direction.

The hybrid CTPGS may be operable in a sub-mode of the power generating second mode in which the first compressor is inactive and all of the compressed air is supplied to the expansion turbine by discharging the sub-system.

In this configuration (or “maximum power generation sub-mode”), maximum power may be achieved to meet Peak Load requirements because all of the compressor work (negative power) has been effectively time-shifted (from a generating period to a charging period).

The second flow network may allow outlet air from the first compressor to pass downstream in the following order through at least the following components (others e.g. other minor components such as boost compressors may additionally be present): the TES system, at least one compressed air store, back to the TES system, and then to the least one expansion turbine, optionally via the at least one combustor.

The second flow network may allow outlet air from the first compressor to pass downstream to the TES system, to then be stored in the compressed air store, to then be returned to the TES system, to then pass downstream to the at least one combustor, and then to the at least one expander turbine.

In certain embodiments, discharging air may undergo an additional heating stage (e.g. very high temperature store) that raises its temperature sufficiently that it is unnecessary for it to be subjected to combustion; and hence, the discharge flow path in such embodiments may omit the combustor and connect directly to the at least one expansion turbine.

The first flow network may be provided with at least a first connection (i.e. junction) between the first compressor (outlet) and combustor (inlet) for connecting that network to the second flow network. There may be a single connection only to the storage sub-system, if compressed air goes to storage and returns from storage along the same flow path (i.e. a shared flow path to storage and back from storage via the TES), or there may be two or more connections, an upstream connection for the flow path to storage and a more downstream connection for the flow path back from storage.

Preferably, the first flow network is provided with a single connection to the second flow network located between the first compressor (outlet) and combustor (inlet), at which connection flow is optionally controlled by a flow selector valve arrangement.

The flow selector valve arrangement may allow the flow in the first network from the compressor towards the combustor to be diverted towards the TES system (for charging), or from the TES system to the combustor (for discharging) or possibly a mixture from both the compressor and the TES system to the combustor (for discharging).

The flow valve arrangements and mechanical coupling arrangements [e.g. clutches and/or gears) are so configured as to provide the necessary flow and mechanistic connections to allow the hybrid CTPGS to operate as required, and may be controlled by one or more controllers, which may be linked to sensors (eg. temperature or pressure sensors) suitably located within the CTPGS.

Particularly for a hybrid CTPGS with more complex power machinery provision (e.g. multi-stages, multiple pumps), the one or more power shaft assemblies may comprise a line shaft powered by a generator or motor/generator (usually a large synchronous motor/generator) and operatively associated with axially offset power machinery disposed along the line shaft, including the at least first compressor and at least first expansion turbine; an ancillary variable power motor/generator or generator may also be provided and detachably coupled e.g. with clutches to the main generator or motor/generator for use in starting the system, maintaining it rotating at low speeds and for providing additional power capacity in peak generation mode.

Complex power machinery provision may mean it is preferable merely to link the compressors and turbines of the gas turbine, and any other power machinery in the sub-system, by electrical coupling only, i.e. where the power machines are coupled to specific respective motors, generators, or motor/generators on respective power shaft assemblies, and the respective motors, generators, or motor/generators are connected to a grid.

If, however, the power machinery provision is simpler, the at least one power shaft assembly may comprise the at least one compressor and turbine of the modified gas turbine unit detachably coupled in-line to a double-ended generator or motor/generator located between them, which is operable to drive the single power shaft. Usually, the at least one generator is a double-ended first motor/generator disposed between the compressor and turbine with (e.g. automatic) clutch mechanisms on each side. More rarely, it may be desirable, to provide just a simple generator on the at least one power shaft assembly for use in the generating modes, with a separate motor for selectively driving the compressor so as to charge the sub-system electrically.

The compression process in an industrial gas turbine normally raises the temperature of the air to high temperatures of between 450 and 600° C. and to a pressure of around 18 bar (more generally around 10-30 bar).

In some embodiments, the hybrid CTPGS may be provided with a storage sub-system in which the compressed air storage is matched to the gas turbine apparatus.

In one hybrid embodiment, the at least one compressed air store (and, usually, all compressed air stores present in the hybrid) is configured to store compressed air at a storage pressure of a similar order (e.g. within 20% of) to the compressor outlet pressure of the primary combustion turbine based system.

Thus, in a highly preferred embodiment, there is proposed a sub-system that is configured to receive, exchange thermal energy in the TES with, and to store, compressed air at an operating pressure of a similar order to the combustion turbine system, such that the compressor(s) and expander turbine(s) of the combustion turbine system are the only power machinery significantly altering the air pressure of the air during charging or discharging of the sub-system; minor pressure altering devices to address/readjust pressure losses with the sub-system may still be required, such as boost compressors, or effusers and/or diffusers. Thus, contrary to conventional CAES, the sub-system is matched to the combustion turbine system.

In this embodiment, the storage pressure is preferably in the range of 10-30 bar (more usually, 15-25 bar, or even 18-23 bar).

In that case, given the primary combustion turbine based system will operate at a nearly fixed pressure, the at least one compressed air store is usually a constant pressure or quasi-constant pressure (e.g. varying by no more than 20% of the mean operating pressure) store., such as, for example, an underwater, constant pressure or quasi-constant pressure compressed air store.

In an alternative embodiment, the at least one compressed air store may be located in the sub-system downstream (i.e. upon charging) of at least a second, higher pressure compression/expansion stage (i.e. beyond the turbine stage) of power machinery so as to provide a higher pressure compressed air store in which compressed air can be stored at an operating pressure significantly higher than (at least 100%, 200%, 300% higher; or more than 20 Bar, or 40 or 60 Bar more than) the compressor outlet pressure of the primary combustion turbine based system.

As an alternative to matching the air storage to the gas turbine, it may be desirable for the sub-system to comprise a conventional, high pressure CAES, in which case the CTPGS will further comprise at least a second, higher pressure, compression/expansion stage, compressing the air to a higher pressure upon charging, and expanding back down from that higher pressure upon discharging with associated power generation (including coupling to an ancillary, optionally variable power) motor/generator). Thus, this will increase the charge/discharge power of the sub-system (i.e. storage element) of the hybrid system, while allowing the OCGT (or derivative) to work at normal design conditions, usually at constant pressure.

In this embodiment, the at least one higher pressure, compressed air store may be a variable pressure compressed air store, optionally selected from high pressure pipes, or a high pressure cavern.

Alternatively, in this embodiment, the at least one higher pressure, compressed air store may be a constant pressure compressed air store, optionally selected from pressure balanced high pressure pipes, or a pressure balanced cavern. In that case, pressure balancing may be supplied by integration into the hybrid CTPGS of a pumped hydro-electricity plant having a top reservoir and a lower reservoir, and wherein the water in the top reservoir of the pumped hydro plant provides a static hydraulic pressure for balancing pressure in the compressed air store located above, at one of more levels, and/or level with, and/or below the level of the lower reservoir.

In this embodiment with a second stage, a pressure management system is preferably provided between the gas turbine and second, higher pressure compression/expansion power machinery to minimise pressure fluctuations.

The pressure management system may comprise one or more venting devices and/or a constant pressure buffer or any other suitable device for minimising pressure fluctuations in the second flow network between the gas turbine and the second higher pressure power machinery stage. For example, the gas buffer could be a large pressure vessel where a quantity of fluid (eg water) is pumped in and out to vary the available volume for gas storage. By adjusting the volume the pressure within the first TES is kept substantially constant.

Such a system is only required if there is a second stage of machinery and a higher pressure (e.g. variable or fixed pressure) gas store, and is preferably an automatic and fast responding system. The preferred point of connecting the gas buffer to the system is after the first TES and heat exchanger that rejects heat to ambient so that the temperature of the gas is coolest. In this way adding or removing gas has a much lower impact on round trip efficiency and machinery does not need to be designed for high temperatures. Alternatively the pressure management system could be located anywhere between the Valve 31 and the second stage machinery.

A pressure management system e.g. gas buffer may be designed to keep the pressure within the first TES quasi-constant for short periods of time to allow the second stage compressor or second stage expander to adjust their mass flow rate of gas to match that required by the first stage compressor or turbine. The size of the gas buffer may be reduced or even eliminated if the TES has sufficient mass of gas within it that any pressure variation is slow e.g. very large packed bed store (or stores in series or parallel). It should be further noted that the gas buffer or other device needs to be able to operate in either direction ie to keep pressure down or to keep pressure up. Consequently during operation it is likely that each time the gas buffer is used the machinery flow rates are adjusted to allow the gas buffer to return to a state where it has broadly equal capacity in either mode of operation.

The pressure management system may buffer a direct or indirect TES system. A TES with direct heat transfer is likely to contain a significant mass of air. Where an indirect system is used, it is likely that there is significantly less air in the system (heat exchange conduits) and consequently any changes in pressure will occur more quickly. Hence, an indirect TES is much more likely to require a gas buffer or a larger gas buffer than a direct TES.

In a highly preferred embodiment, the second, higher pressure, compression/expansion stage comprises positive displacement power machinery, preferably reciprocating linear machinery including piston based machinery, which is more suited than turbine machinery to higher operating pressures and will maintain a static pressure difference across it when the sub-system is actively storing, but not actively charging or discharging. Conveniently, the linear reciprocating (e.g. piston based) power machinery may be a single, reversible machine so as to act as both a compressor and an expander, as required during charging and discharging, respectively.

Wherein the at least one compressed air store is a variable pressure store, the second, higher pressure, compression/expansion stage preferably comprises variable pressure and/or variable mass flow rate power machinery, in particular, where the variable mass flow rate power machinery may be actively controlled. In particular, it is highly preferred to use positive displacement power machinery where variable pressure air storage is desired in excess of the GT system operating pressures.

In order to minimise the operating temperatures of such a second, higher pressure compression/expansion stage, the second, higher pressure compression/expansion stage will nearly always be located downstream (upon charging) of the at least first TES system, so that the heat of compression from the GT stage will already have been at least partly removed.

While the at least one compressor and expander may operate substantially adiabatically and may be designed to operate with an inlet pressure at or around sea level, the second, higher pressure stage may be designed to operate at higher pressures and to operate isothermally or adiabatically, the latter usually involving a much smaller rise in temperature (due to the smaller pressure ratio) than the gas turbine stage.

The second, higher pressure, compression/expansion stage may be configured to conduct substantially adiabatic or isentropic compression and expansion. In that case, a further TES system may be located downstream of the second, higher pressure, compression/expansion stage and is configured to remove at least some of the heat of compression from that stage, prior to entry to the compressed air store.

The first TES system and/or any further TES system may comprise a direct TES comprising at least one thermal energy store forming part of the second flow network and through which the compressed air has a flow path for direct exchange of thermal energy to a thermal storage medium contained within the thermal energy store.

The thermal storage medium may be in the form of a porous storage mass, which may be a packed bed of solid particles through which the fluid passes exchanging thermal energy directly, or, it may comprise a solid matrix or monolith provided with HTF channels or interconnecting pores extending therethrough, or, the fluid may pass through a network of heat exchange pipes that separate it from the storage mass, such as a packed bed of particles (e.g. rocks). In the case of direct thermal exchange, the at least one thermal energy store obviously needs to be configured to receive compressed air of a temperature and pressure of the order typically generated at the outlet of the compressor of a typical combustion turbine (e.g. 15-25 bar and 450-600° C.).

As mentioned above, Applicant's WO2011/104556 proposes a thermal storage system with a high pressure store for storing high temperature heat, wherein the high pressure store is selectively coupled and decoupled to a lower pressure store in a separate circuit such that lower pressure gas may be circulated by gas transfer apparatus between the two stores in the circuit so as to relocate the heat temporarily in a lower pressure (and hence lower cost) store. Accordingly, in the case of the first TES system and any further TES system being based on direct thermal transfer, these systems may be configured for selective connection to, and disconnection from, at least one lower pressure store in a separate circuit (i.e. not in the second flow network) such that the stored thermal energy in such a system may be temporarily transferred by gas transfer apparatus from such a system to the lower pressure store by means of blowing the high pressure system down to the lower pressure and then circulating lower pressure gas in the separate circuit between the system and the lower pressure store, there being provided blow down apparatus for isolating and lowering the pressure in such a system prior to transfer to the lower pressure store. For return of the thermal energy, the process is reversed. This procedure may occur as a batch process, or, as detailed in WO2011/104556 as a continuous process (e.g. during sub-system charge or discharge), if, for example, the first TES system (or the further TES system) comprises a plurality of high pressure stores arranged in parallel, such that they may be simultaneously charging in the second flow network, depressurising (blowing down), transferring to low pressure store in the separate circuit, and re-pressurising (blowing up).

Alternatively, the first TES system and/or any further TES system may comprise an indirect TES comprising at least one heat exchanger forming part of the second flow network and through which the compressed air has a flowpath, for exchange of thermal energy to a heat transfer fluid, the heat exchanger being coupled to a separate thermal energy store such that the thermal energy is transferred indirectly to the thermal energy store via the heat transfer fluid.

However, the first TES system may comprise at least one heat exchanger through which the compressed air flows, such that thermal energy is transferred to a heat transfer fluid also flowing through the heat exchanger, which fluid transfers the thermal energy to at least one thermal energy store such that the thermal energy from the compressed air is stored indirectly in the thermal energy store or stores. In that case, the thermal energy store may comprise a thermal storage medium as described above contained in one or more connected tanks, or may comprise a liquid thermal storage medium such as molten salt or oil. Indirect TES systems advantageously may not require pressurisation of the thermal energy store (only the heat exchanger) assuming that the vapour pressure of the liquid thermal storage medium is low at the required temperatures. A stratified liquid tank or tanks may be used where a liquid thermal storage medium is involved, or respective hot and cold liquid thermal storage tanks connected via a pump may be used.

The first TES system may be configured to withstand a maximum operating pressure within the range of 10-30 bar (preferably 15-25 bar, or 18-23 bar).

The first TES system may be configured to withstand a maximum operating temperature within the range of 450-650° C.

In the case of an adiabatic or isentropic second stage, the at least one further TES system may be configured to withstand a maximum operating pressure of more than 35 bar (or 50 bar or more than 70 bar). The at least one further TES system may be configured to withstand a maximum operating temperature of up to 300° C. (more usually up to 200° C.). Similarly to the first TES system, any further TES systems present downstream of the first TES system may comprise a direct TES system or an indirect TES system. It may be advantageous for the first TES system to be a direct TES system, and for the further TES system to be an indirect system.

Where the first TES system is based on direct thermal transfer, the direct TES comprising the at least one thermal energy store forming part of the second flow network may be configured for selective connection to, and disconnection from, at least one lower pressure store located in a separate circuit (i.e. not in the second flow network), such that the stored thermal energy in the direct TES may be temporarily transferred, at low pressure, by gas transfer apparatus from such a TES to the lower pressure store(s) comprising lower pressure thermal storage media, the stored thermal energy being transferable between the TES and the lower pressure store by passing low pressure gas from the TES to the lower pressure store, and vice versa.

This may occur by blowing the (higher pressure) direct TES down to the lower pressure and then circulating lower pressure gas in the separate circuit between the TES and the lower pressure store, there being provided blow down apparatus for isolating and lowering the pressure in such a store prior to transfer to the lower pressure store. For return of the thermal energy, the process is reversed using the same or additional re-pressurising apparatus. This procedure (for relocating heat in one or more larger, lower pressure stores) may occur as a batch process, or, as detailed in WO2011/104556 as a continuous process (e.g. during sub-system charge or discharge), if, for example, the first TES system 41 (or the further TES system) comprises a plurality of high pressure stores (e.g. 2, 3, 4 or more) arranged in parallel, such that they may be simultaneously, for example, charging in the second flow network, depressurising (blowing down), transferring to low pressure store in the separate circuit, and re-pressurising (blowing up).

Where the first TES system is based on direct thermal transfer, it preferably comprises a direct transfer, sensible heat store incorporating a solid, thermal storage medium disposed in respective, downstream, individually access-controlled layers, so as to enhance the efficiency of heat storage (e.g. up to temperatures of 650° C.).

Usually, at least one heat exchanger is provided downstream of the first TES system, upon charging, and/or downstream of any further TES system, if present. The heat exchanger may be configured to remove any undesired heat of compression in order to ensure that the gas enters the at least one compressed gas store at an appropriate temperature.

In one embodiment, the sub-system includes an additional high temperature store and the second flow network is configured such that air discharging from the compressed air store passes back through the at least one TES and subsequently through the additional high temperature store before passing either into the combustor (with or without fuel-fed heating) or directly into the expansion turbine (e.g. if no fuel-fed heating is required). However, it will usually be simpler from a flow management perspective to direct all of the flow through the combustor even if there is no fuel-fed heating required.

As mentioned above, in certain embodiments, discharging air may undergo an additional heating stage (e.g. very high temperature store e.g. >650° C.) that raises its temperature sufficiently that it is unnecessary for it to be subjected to combustion, and hence, the discharge flowpath may omit the combustor and connect directly to the at least one expansion turbine. This may allow the CTPGS to be operable in a further mode (i.e. sub-mode of the second, power generating mode) in which the sub-system operates to generate power simultaneously with the primary system, but with the former system drawing less additional fuel than usual, or no additional fuel.

The hybrid system described above may be adapted to incorporate any pre-heater system as described below in relation to a further aspect (covering broader hybrid systems).

In a further aspect, there is provided a method of constructing a hybrid combustion turbine power generation system (CTPGS) as specified above, the method including the steps of:

i) providing a primary, combustion turbine based system as specified above;
ii) integrating the at least one compressed air store; and,
iii) integrating the at least first thermal energy storage (TES) system for removing and returning thermal energy to the compressed air upon charging and discharging the store;
so as to arrive at a hybrid CTPGS operable as specified above.

The hybrid CTPGS may be constructed at or near a pumped hydro-electric power plant, and is integrated therewith such that the pumped hydro-electric power plant provides a static hydraulic pressure balancing function for the at least one compressed air store.

In a further aspect, there is provided a method of constructing a hybrid combustion turbine power generation system (CTPGS) as specified above, by the retrofit of an existing combustion turbine plant, the method including the steps of:

i) modifying or replacing the gas turbine functionality so that the first compressor and first expansion turbine may be individually selectively coupled to the first generator or motor/generator (e.g. so that the compressor, combustor and expansion turbine form a primary system allowing the hybrid CTPGS to be operable as stated above);
ii) providing a first generator or motor/generator sized to match the maximum power output of the hybrid CTPGS;
iii) integrating the at least one compressed air store; and,
iv) integrating the at least first thermal energy storage (TES) system for removing and returning thermal energy to the compressed air upon charging and discharging the store;
so as to arrive at a hybrid CTPGS operable as stated above.

In a further aspect, there is provided a method of operating a hybrid combustion turbine power generation system (CTPGS) as specified above, the method comprising:

(i) operating the hybrid CTPGS in a power generating first mode to produce power that does not require discharging the sub-system; and, in periods of higher power demand,
(ii) operating the hybrid CTPGS in a power generating second mode to produce more power than in (i), this involving discharging the sub-system.

The method may involve any one or more modes of operation detailed above or any apparatus as detailed above. In particular, it is likely that the hybrid will operate as in (i) for at least 7 hours/day; and in (ii) for at least 30 minutes a day, or even at least one hour a day, but possibly no more than 4 hours/day, or no more than 3 hours/day or even no more than 1 hour/day. The sub-system will also operate in one of the charging modes detailed above each day. Self-charging and/or electric charging may be undertaken for at least 2 hours a day and is unlikely to exceed 6 hours/day. Thus, such use of CAES storage is of a different ilk to traditional CAES usage where much longer (>10 hours daily) storage is provided.

In a further aspect, there is provided the use of a direct transfer, sensible heat store incorporating a solid thermal storage medium disposed in respective, downstream, individually access-controlled layers to provide a first TES system configured to cool pressurised air at up to 600° C., up to 30 bar, exiting the compressor of a combustion turbine of a hybrid CTPGS modified to include thermal storage and compressed air storage, prior to storage of that air in a compressed air store.

In a further aspect, there is provided the use of a pumped hydro-electric power plant to provide static hydraulic pressure balancing of a constant pressure store which forms the compressed air store of a hybrid CTPGS modified to include thermal storage and compressed air storage.

In a further aspect, there is provided the use of positive displacement power machinery to provide a second expansion/compression, higher pressure stage in a hybrid combustion turbine power generation system (CTPGS) as described above.

In an additional aspect, there is provided a hybrid combustion turbine electricity storage and power generation system comprising:

(i) a combustion turbine based system comprising a first compressor, at least one flow controller, a combustor and an expansion turbine arranged respectively downstream of each other; and,
(ii) an energy storage system integrated with the combustion turbine based system by means of the at least one flow controller, the energy storage system comprising at least a first thermal energy storage TES system for removing and returning thermal energy to compressed air passing through it upon charging and discharging the TES system, respectively,
wherein the energy storage system is configured:—
to store thermal energy in a charging mode in which air is compressed in the first compressor and passes through the first TES system so as to heat the store;
to retrieve thermal energy in a discharging mode in which air passes back through the first TES system so as to cool the store;
   wherein the hybrid system is configured to be operable in the following generation modes:—
   (a) a normal generation mode in which the energy storage system is not operating in the above charging or discharging modes, and the flow connectors are configured to direct heated, pressurised outlet air from the first compressor to the combustor for combustion and then to the expansion turbine for subsequent expansion to produce electrical power; and,
   (b) a discharge generation mode in which the energy storage system is operating in the above discharging mode, and the flow connectors are configured to direct heated, pressurised air from the first TES system to the combustor for combustion and then to the expansion turbine for subsequent expansion to produce electrical power; and,

wherein a pre-heater system is provided upstream of the first compressor with respect to the charging mode, and is configured in the charging mode to preheat air entering the first compressor so as to increase the temperature of air entering the first TES system.

There is further provided a method of operating such a hybrid system, wherein the pre-heater system is used to preheat the air entering the first compressor so as to increase the temperature of air entering the first TES system.

Use of a pre-heater system to add heat at this upstream point during charging (e.g. by a substantially isobaric heat transfer), allows more heat to be stored in the first TES system, this being the first thermal store appearing downstream of that compressor (there may be subsequent downstream stores) without a commensurate rise in pressure (the pressure ratio and hence peak pressure can remain unchanged), which would add to TES system cost. The maximum power produced during the discharge-generation mode will remain unchanged if the pressure and the peak combustion temperature do not change.

In this way, the energy density and efficiency of the hybrid system may be improved and in the discharge generation mode, the system is then able to provide a higher temperature pressurised gas to the combustor such that less fuel needs to be supplied to the combustor (to achieve the same expansion turbine power output). The heat addition may conveniently be by means of a heat exchanger and, because that additional heat stored in the first TES system is discharged through the gas turbine during the discharge generation mode, it does not create a problem of waste heat build-up.

The reason for the improvement in efficiency is that the amount of work carried out per unit mass of gas processed by the compressor increases, which means that the losses associated with processing a certain mass of gas actually fall. Furthermore, the amount of heat in the storage media is related to the mass of gas processed and the increased work translates to a higher energy density in the thermal stores. As the mass flow through the first compressor will fall (due to less dense air), it also allows for a reduction in the size of any second power machinery.

In one embodiment, the energy storage system comprises an adiabatic compressed air energy storage (ACAES) system. This may be a system as described above.

If an industrial gas turbine with a pressure ratio of 17-18 is used then the inlet temperature to the TES is likely to be around 420° C. The first TES system may be provided, at the end which receives outlet air from the first compressor, with an electrical heater configured to provide additional thermal energy to heat air passing through the store. This may raise the gas and hence the storage medium temperature by at least 50, or 70 or even by at least 100° C. (subject to not exceeding the maximum operating temperature of the first TES system). The electrical heater may be configured to operate during the charging mode and, while drawing electrical power, may allow less fuel to be consumed in the combustion chamber during discharge generation mode. In this way, higher temperatures may conveniently be stored in the first TES system without an associated pressure rise that would increase stores cost.

The “maximum store temperature” may, however, also be raised by less direct methods e.g. further upstream.

For increased efficiency, the pre-heater system is preferably configured to supply thermal energy derived from waste heat to the air. This may be waste heat available in real time or that has been stored and may originate either from the hybrid system, associated systems (e.g. downstream), or other separate equipment co-located on-site.

In one embodiment, the pre-heater system preheats the air before it enters the first compressor in the charging mode. Such pre-heating should preferably raise the air temperature by not more than 120° C., more preferably, by not more than 100° C. or even not more than 75° C., and will usually produce a rise in temperature of at least 20° C., or 40° C.

The pre-heater system may comprise at least one heat exchanger provided upstream of the first compressor with respect to the charging mode, which heat exchanger is configured in the charging mode to receive heat (in real time) from at least one further heat exchanger that is located downstream of the first TES system, or a further downstream TES system (i.e. a TES system that is more downstream than the first TES system, for example, located after second stage power machinery), with respect to the charging mode.

In this way, the energy density and efficiency of the system may be improved and in the discharge generation mode, the system is able to provide a higher temperature pressurised gas such that less fuel again needs to be supplied to the combustor. The reason for the improvement in efficiency is that the amount of work carried out per unit mass of gas processed increases, which means that the losses associated with processing a certain quantity of gas actually fall. Furthermore, the amount of storage media is related to the mass of gas processed and the increased work translates to a higher energy density in the thermal stores. As the mass flow through the first compressor will fall it also allows for a reduction in the size of the second compressor. The second expander must still be sized to provide the full flow that the first compressor would normally provide to the turbine at ambient operating conditions.

The upstream and downstream heat exchangers may, however, transfer heat directly between them if configured so as to form a counter-current heat exchanger.

To achieve preheating with heat exchangers so linked across the gas flow pathway (with the correct thermal gradient across them), it will be appreciated that gas circulating downstream of the first TES system must be sufficiently hotter than that circulating upstream of the first compressor. A TES will usually be operated such that a thermal front is retained within, and moves backwards and forwards within the store with storage medium on the hot and cold sides of the thermal front respectively held at approximately the last gas inlet temperature on charging the store (from the hot end) and the last gas inlet temperature upon discharging the store (from the cold end). The latter temperature will therefore be the temperature exhibited by the gas exiting the first TES system during charging (i.e. the last “minimum store temperature” of the first TES, which may or may not correspond to the very initial uncharged (e.g. ambient) temperature) and will normally be higher than ambient). (Usually, once up and running, the store will operate between a maximum store temperature and minimum store temperature, with the thermal front confined to run between the two store ends, but not leaving the store.)

In one embodiment, in the charging mode, the at least one further heat exchanger is configured to receive heat that has been selectively stored in the first TES system, or further downstream TES system, during the previous discharge generation mode by selective operation of that heat exchanger in that mode.

For example, during the previous discharge generation mode, the air inlet temperature to the first TES system, or further downstream TES system, may be selectively raised by supplying at least some heat to the at least one further heat exchanger from an external source.

Alternatively, during the previous discharge generation mode, the air inlet temperature to the first TES system or further downstream TES system, may be selectively raised by selecting the degree to which the at least one further heat exchanger discards heat.

The last gas inlet temperature when discharging the first TES or further downstream TES store (from the cold end) may selectively be raised, during the previous discharge mode, by choosing the degree, if any, at which to discard any of the waste heat generated by the power machinery. The simplest set-up is to configure the further heat exchanger located downstream of the TES in question so that they are bypassed or inoperative (ie bypassed to avoid any pressure drop through the heat exchanger or inoperative so that no HTF flows through them and hence the heat exchanger has no cooling effect after it is raised to approximately the air temperature in the circuit) during the discharge/generation mode, and hence, so that all the (low grade) waste heat becomes stored (at a higher “minimum store temperature”) in the store. In the subsequent charging mode, the heat exchanger downstream of that store is then operative to transfer that heat (in effect, waste heat that was temporarily stored, for example, via a HTF circuit, to the upstream heat exchanger.

Heating the inlet air prior to compression, in this aspect, is counter-intuitive for a number of reasons. In normal operation of a gas turbine GT (combustion turbine), it is well-known that the power output of the GT falls as the air inlet temperature rises. This is because warmer air is less dense so that the overall mass flow rate through the compressor/combustor/expander falls. In addition, it is harder to compress a hotter gas so that the amount of work required for the compression increases with temperature. A normal rule of thumb is that for every degree of temperature rise, the power output of a GT drops by about 0.5%. Furthermore, heat addition to storage systems is usually counter-intuitive because such systems normally require expensive heat exchangers in order to avoid a build-up of unwanted waste heat.

It will be appreciated that in the above aspect, the additional heat is stored during charging in the (hot end of the) first TES system downstream of the compressor, for subsequent discharge to the combustor upon discharge generation, but that the waste heat that may be used as a supply of that heat may be stored either in (the cold end of) the same TES system, or, a TES system further downstream, providing that the store in question is immediately upstream, upon charging, of the linked further heat exchanger which is collecting and redirecting that waste upon charging.

### BRIEF DESCRIPTION OF THE FIGURES

Specific embodiments of the present invention will now be described, by way of example only, with reference to the accompanying drawings in which:

FIG. 1 is a schematic diagram of a conventional open cycle gas turbine (OCGT) system of the prior art;

FIG. 2 is a schematic diagram of a conventional combined cycle gas turbine (CCGT) system of the prior art;

FIG. 3a shows a first embodiment according to the present invention comprising a hybrid CTPGS with integrated thermal energy storage and medium pressure compressed air storage;

FIG. 3b shows a slightly modified version of the embodiment of FIG. 3a;

FIGS. 4a and 4b show an alternative hybrid CTPGS with integrated thermal energy and higher pressure, compressed air storage by means of second stage power machinery, the two embodiments illustrating alternative optional pressure management systems;

FIGS. 5a and 5b are embodiments illustrating possible respective modifications to the upstream, medium pressure apparatus of the systems of FIG. 3a or 4;

FIGS. 6a to 6g illustrate various respective configurations for a preferred flow selector valve arrangement in different operational modes;

FIGS. 7a to 7c illustrate various respective configurations of the preferred flow selector valve arrangement during a start-up;

FIGS. 8a to 8d are embodiments illustrating possible alternative variants of the downstream, higher pressure apparatus of the system of FIG. 4a;

FIG. 8e shows an alternative version of the pumped hydro retrofit of FIG. 8d;

FIGS. 9a to 9d are schematic illustrations of alternative possible power shaft assembly arrangements for use in the hybrid CTPGS;

FIGS. 10a and 10b are schematic flow diagrams of two preferred hybrid CTPGS;

FIGS. 11a and 11b depict one modification that may be made to the hybrid system of FIG. 4b to incorporate a pre-heater system, operating in the charging and discharging modes, respectively;

FIGS. 11c and 11d depict a further modification that may be made to the hybrid system of FIG. 4b to incorporate a pre-heater system, operating in the discharging and charging modes, respectively; and,

FIG. 12 depicts a further modification that may be made to the hybrid system of FIG. 4b to incorporate a pre-heater system, operating in the charging mode.

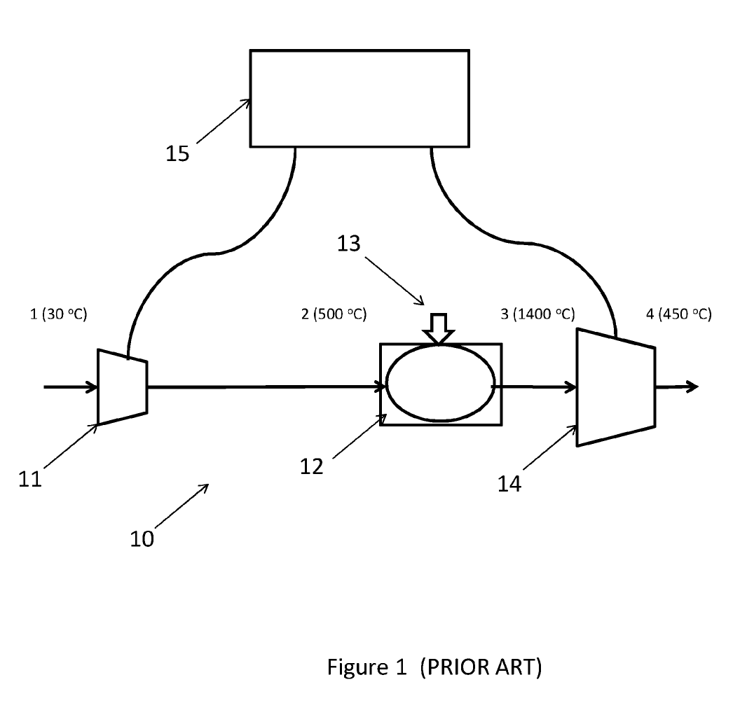

FIG. 1 shows a typical layout of a conventional prior art open cycle gas turbine (OCGT) 10 used for peaking power generation, with an upstream compressor 11 normally directly coupled to a downstream turbine (expander) 14 and driving a generator 15 (e.g. connected to a transformer/grid). Between compressor 11 and turbine 14 is a combustion chamber 12 supplied with natural gas 13. In a normal configuration the compressor, turbine and generator are all directly coupled on the same shaft by drive couplings (not shown). Filtered air enters the compressor at ambient conditions (e.g. 30° C., 1 bar) and is compressed up to a higher pressure and temperature (e.g. 500° C., 23 bar). The hot high pressure air enters the combustion chamber where it is mixed with natural gas and caused to combust, heating the gas to a much higher temperature (e.g. 1400° C., 23 bar). This air is then expanded back to atmospheric pressure in the turbine, which produces more power than the compressor absorbs, hence there is a net generation of power that can drive the generator 15. The cooled air is exhausted from the turbine well above ambient temperature (e.g. 450° C., 1 bar). FIG. 1 shows a simple open cycle gas turbine, however it should be understood by one skilled in the art that there are a number of known different variants on this simple cycle that involve steam injection, reheat, recuperation and/or intercooling.

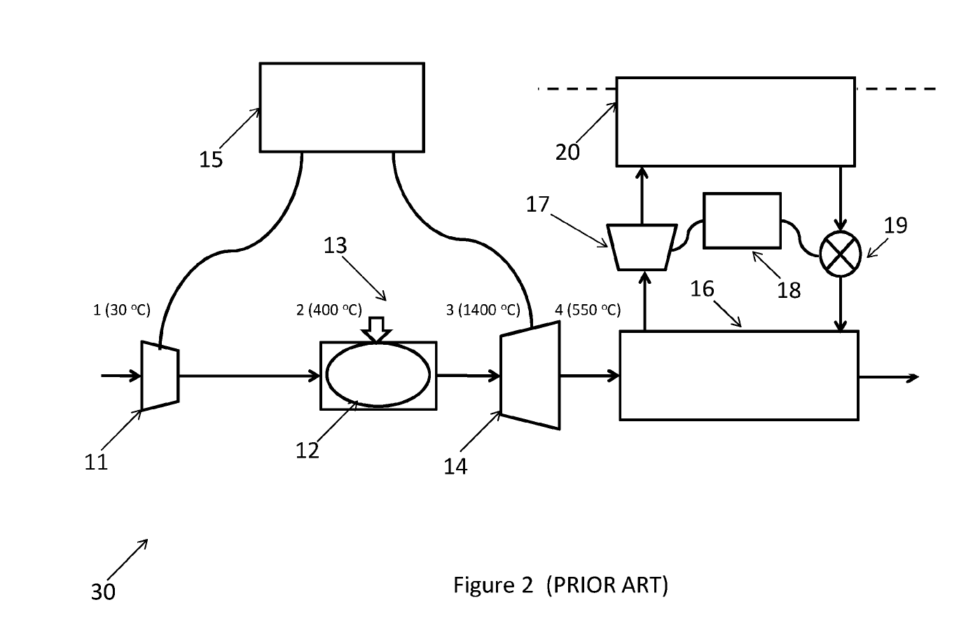

FIG. 2 shows a typical layout of a conventional prior art combined cycle gas turbine (CCGT) 30 used for power generation. The initial section comprises a gas turbine that is similar to that used in the OCGT (10), however it normally operates so that the exhaust temperature is slightly hotter either by operating at a lower pressure ratio or by combusting to a higher turbine inlet temperature. After the exhaust from the turbine 14, the hot high temperature exhaust gas (e.g. at 550° C., 1 bar) enters a heat exchanger 16, where it is cooled while heating a counterflow of water that is at high pressure. The water normally becomes superheated during the heat exchange process and is then expanded through steam turbine 17 to a lower pressure. This steam is then condensed in condenser 20 before being pumped back to a high pressure by water pump 19 to return to the heat exchanger 16. The condenser 20 is normally supplied with a cooling water flow from a river or the sea. Steam turbine 17 is normally directly coupled to water pump 19 by generator 18 and the expansion of the steam in the steam turbine 17 produces more power than the water pump 19 absorbs, resulting in a supplementary net production of power.

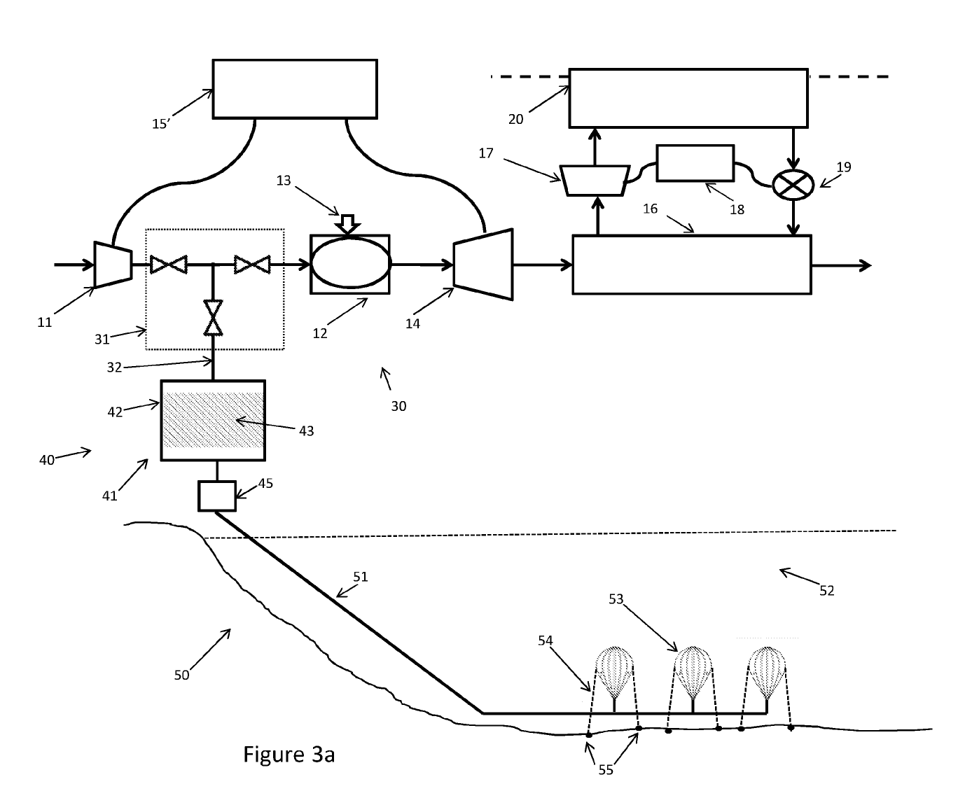

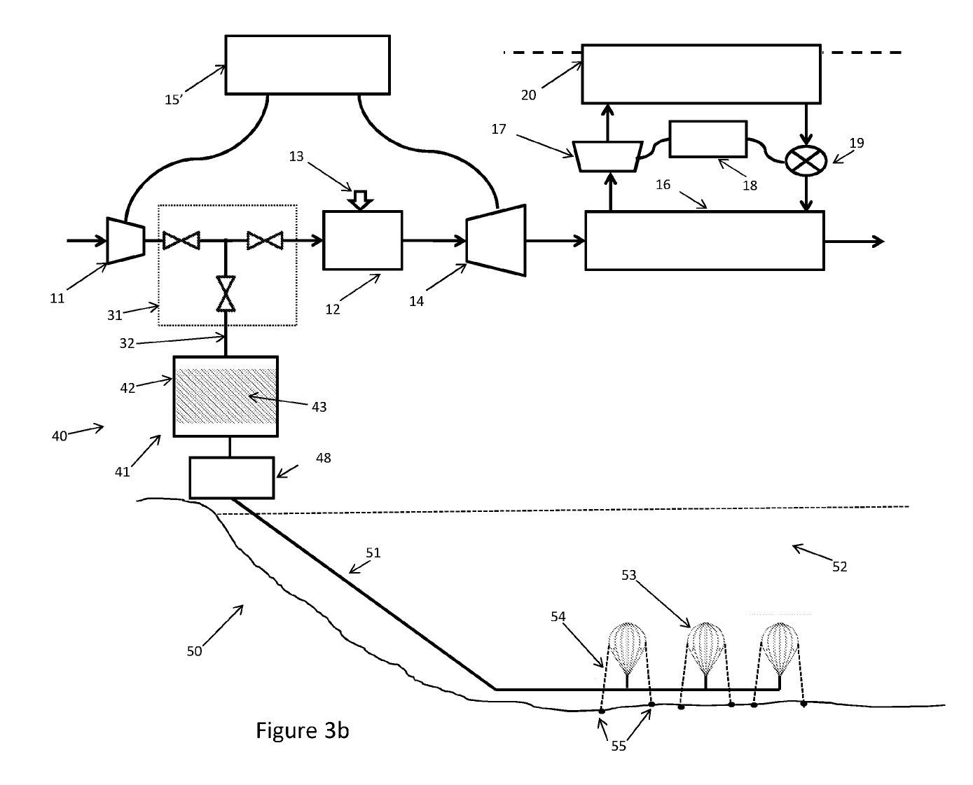

FIG. 3a shows a first embodiment 40 of the present invention comprising a hybrid CTPGS based on a CCGT but with an integrated energy storage system involving both thermal energy storage and compressed air storage. The compression process inside an industrial gas turbine normally raises the temperature of the air to high temperatures of between 450 and 600° C. and to a pressure of around 18 bar. In this embodiment, the thermal energy storage stores heat of this order and, after cooling of the compressed air has taken place, the compressed air storage stores gas at this order of pressure, such that advantageously, additional power stages or cooling stages are not required. For convenience, such storage may hereinafter be referred to as medium pressure storage (i.e. storage of the order of pressure of the compressor outlet pressure of the primary combustion turbine based system) which, for example, will usually be about 10-30 bar, more likely, 15-25 bar, or even 18-23 bar. (Aeroderivative gas turbines can operate at higher pressures, eg using ratios of 30:1, however they are not normally used in CCGT's.) The upper limit for a combustion turbine is the temperature that the last stage of the compressor can normally tolerate. This is currently around 600° C. for continuous running although hotter temperatures can be achieved for short duration. Given that the gas will normally enter the turbine at roughly constant pressure, this embodiment also uses (a preferred type of) constant pressure gas storage.

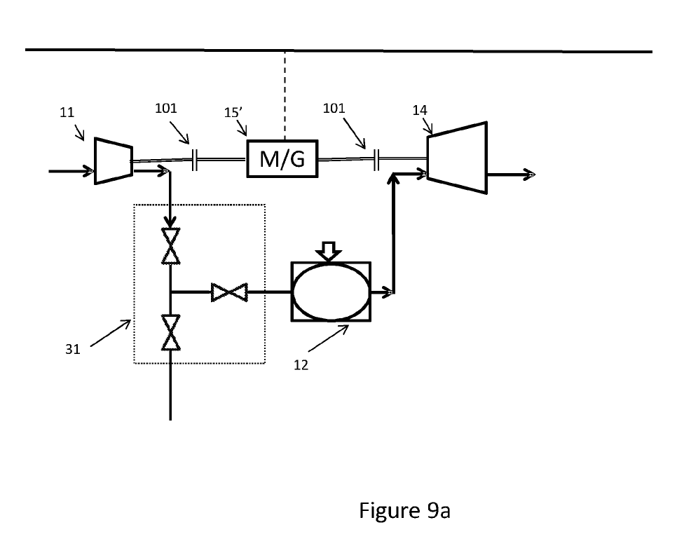

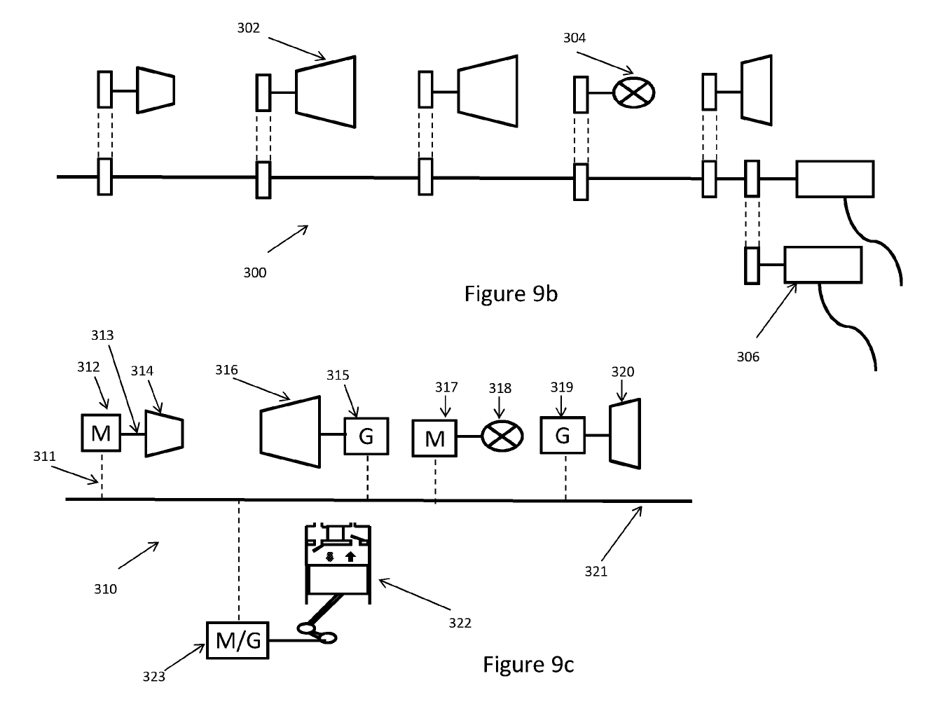

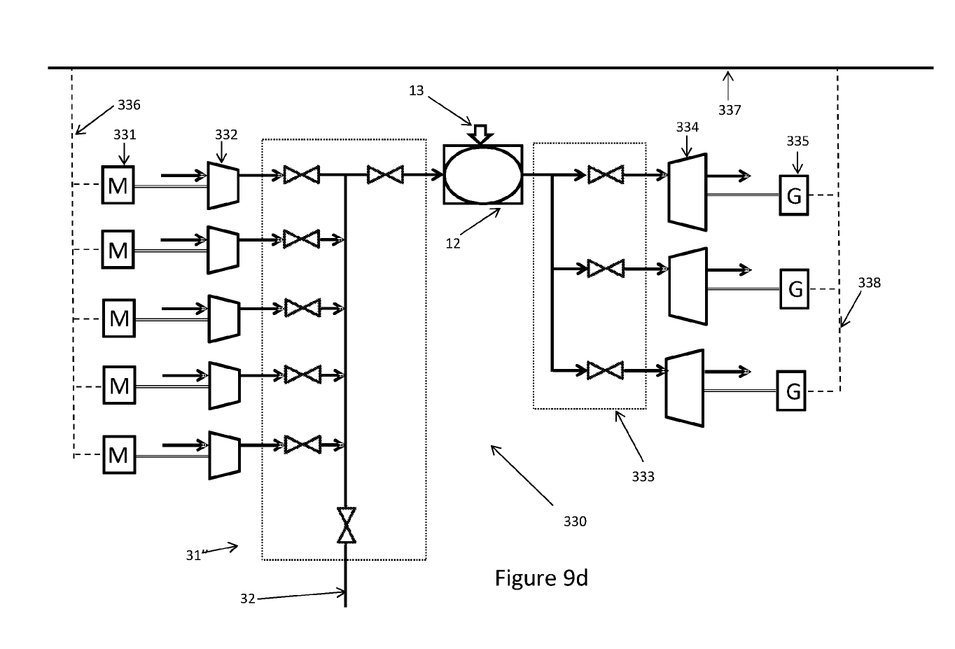

The hybrid system comprises a CCGT 30 as previously described, except that the motor/generator means is preferably a double-ended motor/generator 15′ located in-line between the compressor 11 and the turbine 14 that can be selectively connected to either or both by means of clutches 101, as shown in FIG. 9a, which depicts the mechanical coupling of the compressor and turbine to the motor/generator on a single power shaft assembly.

As also shown in FIG. 9a, there is a gas flow selector valve arrangement 31 between compressor 11 and combustion chamber 12. Flow selector valve arrangement 31 allows the flow from the compressor 11 to be diverted to first thermal store 41 (for charging) or from first thermal store 41 to combustion chamber 12 (for discharging) or possibly a mixture from both compressor 11 and first thermal store 41 to combustion chamber 12 (for discharging), or a combination of the above. The selector valve may simply connect all three spaces and have simple shut-off or non-return valves so that flow cannot go in the wrong direction through either the compressor or the combustor. In this way it is possible to configure a system where if there is any mismatch in flow between the compressor and the turbine then the system is able to automatically balance by allowing either flow in or out of the first thermal store 41 to balance the system. Hence, the hybrid CTPGS may have a discharge mode in which the first and second flow networks allow a very fast response to a rise in power demand through the declutching of the compressor.

First thermal store 41 comprises a thermally insulated vessel 42 and thermal storage media 43 which may be any suitable TES apparatus, a mentioned above. Thermal media 43 may comprise a packed bed of suitable thermal media such as high temperature concrete, ceramic components, refractory materials, natural minerals (crushed rock) or other suitable material. Thermally insulated vessel 42 must be designed so that the high pressure flow (usually at between 15 and 25 bar and between 450-600° C.) can pass through the vessel transferring heat directly to/from the thermal media 43. As the media 43 is in the form of a packed bed with direct heat exchange to compressed gas, the thermally insulated vessel 42 will need to be an insulated pressure vessel.

An example of a thermal store that may be especially suitable for removing/returning thermal energy directly at high temperatures of at least 500-600° C., and pressures up to 30 bar, is the solid fill thermal store described in detail in Applicant's published application WO2012/127178. As described above, the valved, layered store has functionality allowing it to store thermal energy in a controllable manner.

Charging: When charging the first thermal store 41, flow selector valve arrangement 31 diverts hot high pressure gas to the top of the thermal store via diffuser/effuser pipe 32 and the gas passes through the thermal media 43 cooling as it progresses.

Diffusers/effusers are commonly used in flow handling apparatus to minimise irreversible energy losses associated with bends/changes in ductwork. Pipe 32 preferably widens in the downstream (charging) direction to decelerate the flow (as a diffuser) as it approaches the thermal store travelling from the selector valve 31 to the first thermal store 41, and accelerates the flow (as an effuser) through its convergence when travelling in the reverse direction, and its geometry should be optimised for efficient pressure recovery.

The reason for the diffuser is that heat exchange is a time based process and the slow flow of gas through the bed is preferred to allow sufficient time for high quality heat exchange; large cross-sectional areas in large packed bed stores are therefore preferred. The output from the compressor outlet of a gas turbine would be of very high mass flow rates at high speeds in small ducts. It is therefore desirable to slow the flow rate down while increasing the area of the ducting such that the flow of gas entering the stores is at a velocity more appropriate for the heat exchange part of the process. Losses of dynamic pressure also apply to turning high speed flows around corners in ducts. Consequently it is also good practice to use turning vanes where appropriate to change flow directions. It is possible to combine both a turning vane and an effuser or diffuser.

As described further below, the system may operate in a charge only mode in which the turbine section is declutched from the motor/generator, which then acts as a motor to drive the compressor, with all the compressor outlet flow entering the thermal store. This mode uses only electrical energy (e.g. from a local grid or another hybrid CTPGS) for storage. Alternatively, charging may occur using energy from combusting fuel by normal operation of the combustion turbine driving the compressor and generating some power, where only a proportion of the compressed air is diverted through the thermal store as opposed to it all passing through the combustor.

The cooled high pressure gas then leaves the thermal store 41, where it may be further cooled in an optional additional heat exchanger 45 so that the temperature is close to ambient temperature.

The higher pressure gas then leaves optional heat exchanger 45 and enters “medium pressure” gas storage 50. Medium pressure gas storage 50 is designed to store gas at a near constant pressure that is consistent with the normal peak operating pressure of the CCGT 30.

Medium pressure gas storage consists of a pipe 51, body of water 52, one or more flexible gas holders 53, cables 54 and anchorages 55. The depth of the body of water 52 above the flexible gas holder 53 determines the operating pressure of the system. For example, if the water depth is 170 m and the height of the flexible gas holder is 5-10 m, then the operating pressure of this system will be in the region of 16 bar above atmospheric pressure ie 17 bar absolute pressure. In operation when charging, compressed air enters pipe 51 and passes down the pipe to be stored in one of the flexible gas holders 53. The flexible gas holders can be thin walled structures as the water pressure balances the gas pressure. As more gas is added the structures inflate and the level of the body of water 52 rises very slightly. Flexible gas holders 53 are secured to the bottom to resist buoyancy loads by cables 54 and anchorages 55. There are a number of different potential solutions for underwater storage of compressed air, for example, the undersea air storage bags being developed by Nottingham University US20090002257 (Thin Red Line Aerospace Ltd.) or proposed in WO2011099014 (Arothron Ltd).

When discharging the process is reversed. The compressed air leaves pipe 51 and is heated as it passes through thermal media 43. The hot high pressure gas is then diverted by valve 31 so that it enters the combustion chamber and passes through the turbine 14 of the CCGT. Thus, the gas follows the same flow path in reverse through the sub-system upon discharging.

In this embodiment, switching to a discharge mode may be fast. The compressor feeds a certain mass of gas into a space and the turbine removes a certain mass of gas from the same space. If the two amounts are equal then the pressure in the space is constant. This space is also connected to the first thermal store, which is connected to the compressed air store. If the valve arrangement 31 has all valves in an open position and if the flow from the compressor is reduced, for example by altering inlet guide vanes, then the flow from the compressed air store will automatically compensate as the compressed air store is ideally kept at quasi constant pressure. This also means that if the compressor is suddenly switched off (declutched) then there will be a very fast increase in power output of the system as the compressor load will disappear and the store will provide the gas flow to the turbine without requiring any additional power. Potentially the jump in power might take in the region of 1-2 seconds and account for a 50% increase in power output. Valve arrangement 31 would also need to ensure that flow could not exit through the compressor by closing the valve to the compressor, which could be a non-return valve.

Possible modes of operation for a hybrid CTPGS system (such as an OCGT, or CCGT or other derivative) according to the present invention (e.g. FIG. 3 and later embodiments) are described below.

For these modes, the gas turbine has been modified so that the compressor and turbine can be run independently or together. As is apparent below, because the cycle has a significant amount of back work from compressing air, the effect of installing the storage system is to effect time shifting of that work, allowing a significant and fast “jump” in power to be achievable whenever stored compressed air partly or fully replaces air directly from the compressor.

This ability to increase power rapidly is very important from a grid management perspective. The system operator needs to maintain the system frequency by balancing the power input and output to the grid. If there is not enough power then the frequency will start to fall and more generation must be brought on line. If the there is too much power then the reverse must occur. The electricity grid is made up of millions of individual consumers so that it is relatively easy to predict the likely demand and to respond to changes from forecast amounts. However, generation is made of a few much larger components. Base Load plant normally has 600 MW units, but these may get as large as 1800 MW in future to improve efficiency further. When one of these units ‘trips’ or is forced to disconnect from the grid there is a very large and unforeseen drop in generation. This means that the system operator has to bring a large amount of new generation on to the system very quickly to avoid the frequency dropping outside of limits. Normally most of this fast response is provided by pumped hydro, which has a response time of 15-60 seconds. Once the initial problem is resolved other generating units are brought on line, normally anytime from 10 minutes to 2 hours, and the fast response units are switched off. However, it can be clearly seen that a system that allows rapid increases of power for short durations is of significant use to managing the system.

A) Normal Generation—e.g. Intermediate Operation

In normal generation, the OCGT, or CCGT (or other derivative) operates as a normal power station and burns fuel to generate electrical power. No air is stored or recovered to/from the air storage.

B) Discharge (with Gas Burn) e.g. Intermediate or Peak Load Operation

In this mode, the first compressor is stopped or its capacity is reduced and the difference in gas flow is supplied by hot high pressure gas from the air storage. The hot high pressure gas is heated further by passing it through a combustion unit.

C) Charge (Storage) Only

Single Unit CTPGS (Uses electricity only; no power generation) In this mode, the first compressor is driven by electrical power taken from the grid and the turbine does not operate. It is necessary to divert the flow of hot compressed gas from the compressor to the storage section. Normally the turbine would be de-clutched from the compressor shaft. Since the compressor work input is electrical, the cost of this is independent of the price of gas.

Multiple Unit CTPGS

If there are multiple units, the electrical power to charge one unit may, alternatively, come directly from another unit. There are costs and losses associated with transmission of electricity. For example a normal transformer is between 98 and 99.5% efficient. In most grids there are also costs associated with buying and selling electricity. Consequently one mode of operation of the system is where multiple generation units are installed and one or more of the generating unit is used directly to drive the storage process in the remaining units. Thus, in the case of a power facility with multiple hybrid CTPGS's according to the present invention, one fuel fed CTPGS may be assigned to generate electricity solely for the purpose of providing charging to one or more other CTPGS's, where the latter are not simultaneously being required for power generation.

D) Self-Charge (Storage) (Uses Fuel; Some Generation)

In this mode, a single hybrid CTPGS self-charges by normal operation of the combustion turbine driving the compressor, except that some compressed gas leaving the compressor is diverted into the sub-system for storage. Hence, this mode requires fuel for the combustion turbine. This mode with a single unit effectively allows the unit to generate power and also to consume some of that power. This should allow for a more flexible unit from a grid perspective ie it can run at 90% gas flow rate through the turbine, with some of the power being used to drive the compressor at 100% gas flow, with the difference being stored.

E) Discharge (without Gas Burn)

In this mode, the compressor is stopped or its capacity is reduced and the difference in gas flow is supplied by hot high pressure gas from the storage process being fed directly into the expansion turbine. However, the hot high pressure gas is NOT heated further by combustion. Consequently the round-trip efficiency of this mode of storage will be much lower than that which occurs if it is as a boost to a system that involves gas combustion.

As described below, this mode may be used where the hybrid CTPGS includes an additional very high temperature thermal store (e.g. 500-1400° C.), for example, with an electrical heater, that serves to raise the temperature of the returning stored gas prior to entering the expansion turbine, as an alternative heating method to fuel combustion.

F) Combinations of the Above

Various combinations of the above modes are also possible. For example, there may be modes of operation where the system is being simultaneously charged and discharged but where the input is driven by one power source or grid and the output feeds a different grid or supply. This may be particularly useful where the system is balancing a very varied input and needs to provide a very smooth output, or where the input is smooth, but the output is varied or finally where both the input and output are both very varied.

Some of the above modes of operation are summarised in Table 1 below, with exemplary power figures, by way of example only.

TABLE 1
Modes of Operation for System of FIG. 3(i)

| | Power | Status of | | | | Net |
|---|---|---|---|---|---|---|
| Power | Sources | Storage | | | | Power |
| Generation | being | (Thermal | | | Steam | (without |
| Mode | used | and CAES) | Compressor | Turbine | Turbine | losses) |
| A) Normal | Fuel only | Inactive | −80 MW | +200 MW | +60 MW | +180 MW |
| Generation | | | | | | |
| B) Discharge | Storage + | Discharging | 0 MW | +200 MW | +60 MW | +260 MW |
| (with gas | Fuel | | [Inactive] | | | |
| burn) | | | | | | |
| B′) Discharge | Storage + | Discharging | −40 MW | +200 MW | +60 MW | +220 MW |
| (with gas | Fuel | | [Reduced | | | |
| burn) | | | activity] | | | |
| C) Charge | Electric | Charging | −80 MW | 0 MW | OMW | −80 MW |
| Only | Grid | | | [Inactive] | [Inactive] | |

Referring to Table 1, assuming that in normal (e.g. Intermediate) Load operation mode A, the compressor might require 80 MW of power to drive it and the turbine generates 200 MW of power, this means that the gas turbine part of the system may generate net power of about 120 MW. The steam turbine part of the cycle (i.e. the bottoming cycle) may generate a further 60 MW, for example, which means the total power output of the CCGT may be 180 MW.

In view of the high back work of the compressor, by reducing or eliminating the amount of compressed gas produced by the compressor and partly or fully replacing it with hot, pressurised gas from the air storage, it is possible to meet intermediate and peak load demand. Thus, Discharge Mode B with Gas Burn shows that a net power of +260 MW is achievable for maximum capacity during Peak Load.

This does not take into account losses, which have been previously mentioned. The result of losses is normally seen in a number of ways. For example the compressor is normally driven directly by the turbine on the same shaft with very low losses from this process. Hence it uses 80 MW of shaft power, however if this is driven by an electric motor that is, say 98% efficient, then the electric motor will absorb 81.63 MW on charging. Likewise on discharging the 80 MW of additional shaft power is now converted to electricity with 98% efficiency and hence only 78.4 MW extra would be generated. The result of this is that some losses will be seen by an increase in the power required to charge the system, some losses by a decrease in power output of the system and still other losses by a reduced time to discharge over the time required to charge. Where these losses are shown is normally a matter of how the different components of the system are designed, however absorbing losses on charge is normally a good thing as this tends to happen at off-peak periods. Maximum power output on discharge, normally at peak periods, is also desirable. Furthermore different implementations of TES and equipment will give different sets of losses. For these figures therefore we have not included losses, but it should be understood that they will occur, for the stored part of the energy, at some stage in the process ie by effecting power in, power out or duration of stored energy.

Discharge mode B′ with Gas Burn shows the system operating under Partial Peak Load with a mix of hot, pressurised gas from the air storage and compressor generated gas, the latter resulting in a drop to a net power of +220 MW. Intermediate Load could be met solely by reducing the compressor work by altering the inlet guide vanes and then compensating with additional flow rate of hot, pressurised gas from the air storage.

The apparatus may switch from Mode A to Mode B′ operation within a short response time of seconds to minutes by turning the compressor down, or to Mode B by decoupling the compressor. If the valve configuration is in the correct setting then once the latter is online, ramping up and down in Intermediate Load (or Peak Load) may be achieved relatively seamlessly as the connections have been made and only flow throughputs need adjusting by changing compressor flows.

As described above, Mode C is a non-generational mode of operation in which the TES and air storage are respectively charged.

Any storage losses in the FIG. 3a embodiment will be related to the additional electrical losses that occur at charge and discharge, as well as to the thermal and pressure losses in the first thermal store 41. There may be some smaller pumping losses that occur in the medium pressure gas store. With a good thermal store design, the round trip efficiency of this storage system may be quite high, for example, over 75% or 80% or even in the region of 85-90%. More importantly this system does not require any additional power machinery, although it does require a larger motor/generator 15′. The generator of the conventional unmodified CCGT would have had an output of only 180 MW, whereas the hybrid CTPGS system has an output of 260 MW. Consequently it will be necessary to size the motor/generator 15′ for the higher power output.

Referring to FIG. 3b, this shows a modified version of the embodiment of FIG. 3a where the heat exchanger 45 is replaced with a heat exchanger and boost unit 48. In this case there is both a heat exchanger and an additional boost compressor to ensure that there is sufficient pressure to inflate the gas storage devices. The pressure ratio of the boost compressor is likely to be quite low, in the region of 1:1.1 or 1:1.2, and may be no more than 1:1.4 for the ratio of charging air entering boost compressor to charging air leaving boost compressor (towards underwater storage). The boost compressor may be desirable if there is likely to be some loss of dynamic pressure when the flow is diverted around a corner or when the flow is accelerated or decelerated in the diffuser/effuser 32, or when atmospheric pressure is low, or in the case of a lake when water levels are changed, such that the total static pressure in the store is likely to be less than the total pressure (static plus dynamic) that the combustor would otherwise receive. By adding a small boost compressor in this location normally operating when charging, it is possible to ensure that the static pressure in the store is at a correct level so that when air is returned to the flow selector valve arrangement, it has the correct total pressure that it would have had if such losses had not occurred. The advantage of boosting on charge is that this absorbs the losses when electricity prices are normally low and does not reduce the power output of the system. If the boost was to occur on discharge then this would reduce the power output at peak periods, which is less desirable.

In the FIGS. 3a and 3b embodiments, the thermal storage and compressed air storage is tailored to operate with pressures (and temperatures) of the same order of the combustion turbine so that a constant pressure air storage system, namely, flexible underwater storage vessels, are preferably used. As has been explained a boost compressor can ensure that the effect of pressure losses (low pressure recovery and pressure drop through the TES) can be absorbed during the charge part of the cycle.

However, there are various alternative options for storing pressurised cooled air as follows:

Air Storage at Medium Pressures (e.g. Similar to the GT Compressor Outlet Pressure)
i) Quasi-constant pressure storage in a flexible underwater vessel at the correct depth for the particular pressure at which the gas turbine operates ie approximately 150-250 m below the water's surface.
ii) Quasi-constant pressure storage in an underground cavern that is close to the surface (<600 m depth). Ideally this cavern will have a quasi-constant pressure that may be maintained by a water column. The reason it is quasi-constant is that the water level at the top of the column might vary by 5m between charge and discharge, which means the pressure would vary by 0.5 bar. This cavern could be mined from rock and lined with steel or it could be a previously existing mine that is gas tight. If the underground cavern is in the form of a salt cavern then the water column may be a brine column. This method normally requires a surface reservoir and additional pumping equipment for the water if the depth of the cavern is not correct for the gas turbine pressure ratio.
iii) Above ground storage is possible in man-made pressure vessels, however these are likely to be quite large and the energy density at these pressures is relatively low. Consequently for above-ground storage it is likely to be better to use storage at higher pressures.

### Air Storage at Higher Pressures

The hybrid system may undergo a further compression process to a higher pressure, in which case other methods of storage e,g, typical CAES storage may be used.
iv) The high pressure hot gas (usually raised in temperature by 100-150° C.) can then be cooled again either directly in a second packed bed store or indirectly via a heat exchanger to a thermal storage medium. The gas may then be stored in an underground cavern at high pressure. The cavern would normally be in the range of 60-120 bar. The pressure in the cavern may vary or it may be pressure balanced. If the pressure varies then there is likely to be only a limited range of variation eg 60 to 80 bar or 100 to 120 bar. The further compression process may be via turbo (axial or centrifugal or a combination of both) compressors/expanders or positive displacement compressors/expanders (reciprocating, sliding vane, rotary screw etc.) machinery. Some advantages of positive displacement (such as reciprocating) machinery is that it can easily tolerate a varying pressure ratio, the gas flows exiting the machinery are normally slower so that the dynamic pressure element of the flow is low and hence losses in effusers/deffusers are also slow and the same machinery can potentially be used for both charge and discharge.
v) Alternatively, the higher pressure gas storage may be located on the surface in manufactured pressure vessels such as high pressure steel pipeline. These vessels may or may not be pressure balanced by a liquid, such as water.
vi) They could also be located underwater at greater depths e.g. 500-600 m.

Although the second compression/expansion stages are described as being adiabatic/isentropic, such that sensible heat is generated and requires storage in a thermal store, the second higher pressure stage does not always require a TES as an alternative is where the second compression/expansion process is isothermal or quasi isothermal. This normally involves spray injection of water into the compression and expansion space such that the gas remains at a similar temperature, say within 20° C., but during compression the water is heated up by say 20° C., and this water is normally stored (effectively acting as a store of heat) and re-injected on expansion, when it cools down by a similar amount. This is appropriate because the stored air still passes through the first thermal store to receive the necessary “turbine level heat” before entering the combustion turbine.

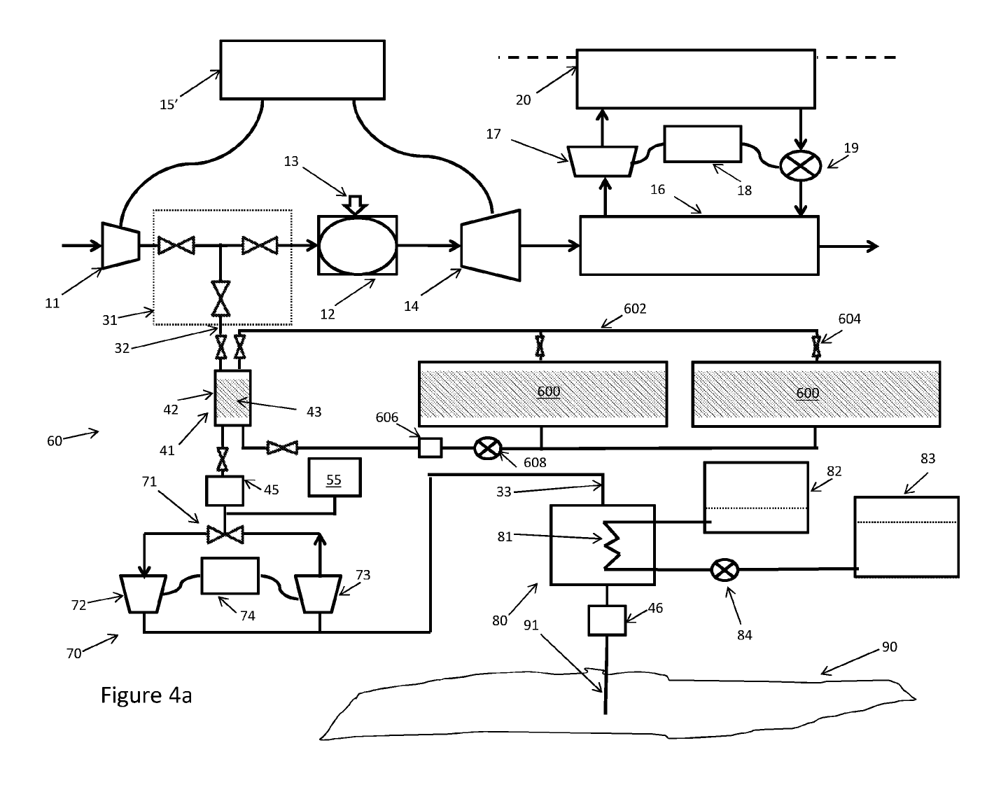

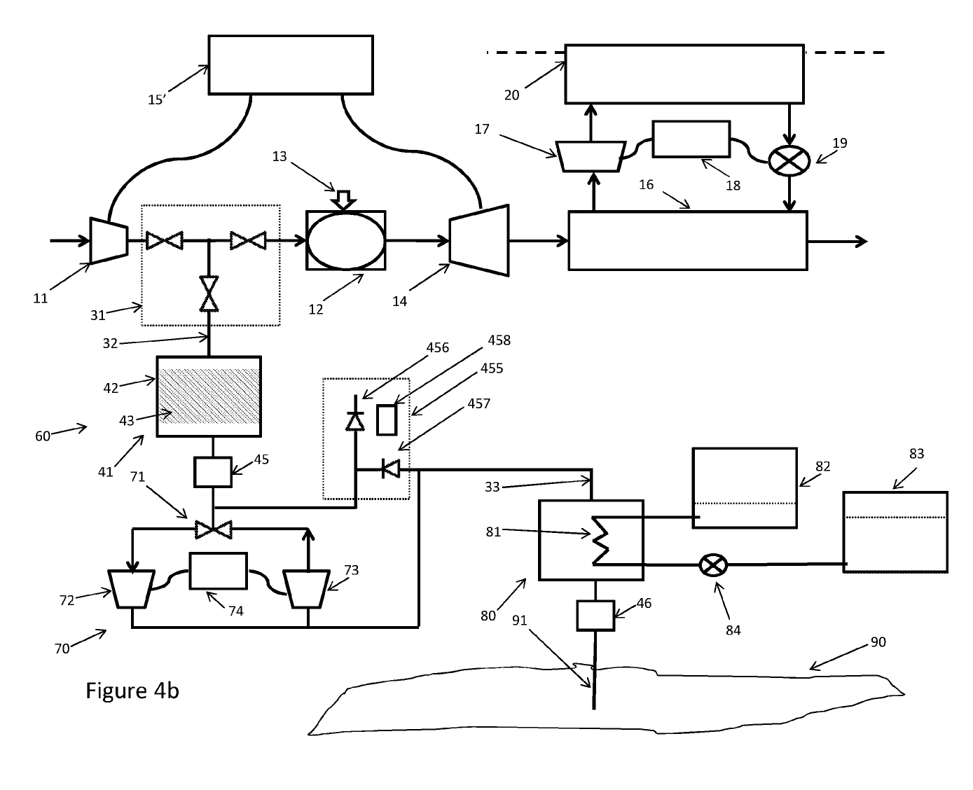

FIGS. 4a and 4b show a second hybrid CTPGS with integrated thermal energy and compressed air storage, in accordance with the present invention, but where the hybrid system includes a second compressor/expander stage such that air storage can occur at much higher pressures. The two embodiments illustrate alternative TES systems and alternative optional pressure management systems that are desirable when a second stage of power machinery is running alongside the gas turbine.

Turning first to FIG. 4a, the CTPGS 60 is designed to incorporate compressed air storage at higher pressures, which advantageously allows traditional CAES storage facilities to be used (e.g. caverns which need to operate at higher and indeed, usually variable pressures) and which can generate more power. To achieve this, a second compression/expansion stage is added, after the TES system, in the form of a second, higher pressure power shaft assembly, as described below.

The system comprises CCGT 30 as previously described with motor/generator means 15′ that can be selectively connected to the compressor, the turbine or both. In addition there is a selector valve 31 between compressor 11 and combustion chamber 12. Selector valve 31 allows the flow from the compressor 11 to be diverted to first thermal storage system 41, or from first thermal store 41 to combustion chamber 12, or possibly a mixture from both compressor 11 and first thermal store 41 to combustion chamber 12. Diffuser/effuser pipe 32 is designed to decelerate the flow as it approaches the thermal store travelling from the selector valve 31 to the first thermal store 41 and to accelerate the flow when travelling in the reverse direction.

First thermal storage system may be a simple TES store 41 based on direct thermal transfer as described in FIG. 3 above, or it may be a hybrid store with “blow-down functionality” as illustrated in FIG. 4a and described later below.

Assuming for now the store is a simple TES store, when charging the first thermal store 41, valve 31 diverts hot high pressure gas to the top of the vessel 42 and the gas passes through the thermal media 42 cooling as it progresses. The cooled high pressure gas leaves the first thermal store 41 where it may be further cooled in an optional additional heat exchanger 45 so that the temperature is close to ambient temperature.

The higher pressure gas leaves optional heat exchanger 45 and is diverted via valve 71 so that on charging it passes through a second compressor 72 and on discharging through a second expander (e.g. turbine) 73. Second compressor and expander are selectively coupled to second motor/generator 74 on a second higher pressure power shaft assembly either separately connected to the grid, or in an alternative embodiment could be selectively coupled to motor/generator 15′ and avoid the need for an additional motor/generator. During charging, the temperature and pressure of the gas is raised by second compressor 72 so that the pressure is approximately equal (but slightly higher) than the pressure in the high pressure gas store 90. If the second compressor and expander are turbo machinery (generating faster flows), it is preferable to have a second diffuser/effuser 33 to decelerate/accelerate the flow to improve efficiency.

When second stage machinery is provided alongside the gas turbine, the second stage machinery usually needs to be able to match the first stage machinery in terms of gas mass flow rates and be able to respond quickly to any mismatch in such rates. Most compressors or expanders machinery will vary the mass flow that is processed in response to a change in inlet conditions. For example, if you double the base pressure then a reciprocating compressor will process twice as much gas. This can be used to provide a balanced system—ie let the pressure rise until the mass flows through each part of the system matches. However, that is not a controlled system and will not necessarily reach an equilibrium that is at the normal operating condition of the GT.

With varying weather, the atmospheric pressure varies with time as does the external inlet temperature to the GT, consequently the mass flow through the GT and the actual pressure achieved will vary with the time of day. This means that it is preferable that the second stage power machinery:

(i) Can actively control mass flow rates to ensure that equilibrium is achieved at the GT's operating conditions and not some other pressure;
(ii) Can operate with varying pressure ratios; and,
(iii) Can preferably perform both of the above at constant speed.
To that end, the second stage power machinery is preferably positive displacement machinery.

Between heat exchanger 45 and valve 71 is a connection to gas buffer 65. Second compressor 72 and expander 73 will usually be designed to keep the pressure within the first thermal store 41 roughly constant. This means that if there is flow that is to or from the main GT then the second compressor or second expander should operate to process an equivalent amount of gas. If they do not, then the pressure in the first thermal store and pipework will rise or fall. If there is only a limited volume of gas, then this pressure could change very quickly so the use of a constant pressure buffer as a pressure management system when a second stage of power machinery is present is desirable to absorb any short term mismatches between the respective gas flow rates.

It should be noted that a first thermal store configured as a packed bed (e.g. of particles) has the additional advantage in that there is normally a significant quantity of compressed gas kept within the store that acts as a buffer between the main GT and the second compressor 72 and second expander 73. The use of a packed bed thermal store (as opposed to a heat exchanger coupled to a remote store) means that there is, in addition to any gas buffer, a significant mass of gas present that reduces the rate of change of pressure caused by a mismatch.

For the reasons described above, it is preferable that the second compressor and expander are both able to process variable mass flow rates of gas to different pressures to ensure that the first stage of the system is maintained at a roughly constant pressure. If the second compressor or expander is not fast responding then any switching of modes will also be slower.

Second thermal storage system or store 80 shows a two tank system that comprises a heat exchanger 81 and thermal fluid stores 82 and 83. Thermal fluid stores 82 & 83 may contain a heat transfer fluid such as a mineral oil that is suitable for the temperatures involved. The temperature range of this stage should usually be lower than that of the first thermal store so that it should be possible to store the heat of compression in only one fluid. The second thermal store is a two tank system, where thermal fluid store 82 is hotter and thermal fluid store 83 is colder. An alternative approach would be to use a single stratified store. There is a circulation pump 84 to circulate the heat transfer fluid from the thermal fluid store 83 via the heat exchanger 81 to the thermal fluid store 82. The heat exchanger is preferably a counter-flow heat exchanger.

When charging the second thermal store 80 (simultaneously with the first thermal store), valve 71 allows hot high pressure gas to pass into the second compressor for further compression and then it passes through the heat exchanger 81 cooling as it progresses. The cooled high pressure gas leaves the second thermal store 80, where it may be further cooled in an optional additional heat exchanger 46 so that the temperature is close to ambient temperature. The gas passes through pipe 91 to high pressure gas storage 90, which is an underground cavern designed to operate over a variable pressure range (with a minimum pressure of, for example, over 80 bar, or over 90 bar).

When discharging the process is reversed. The compressed air leaves high pressure gas store 90 via pipe 91 and is heated as it passes through second thermal store 80. The hot high pressure gas is then diverted by valves 71 so that it is expanded in expander 73 (with some power generation), before passing back through the first thermal store to receive its stored heat before it enters the combustion chamber and passes through the CCGT.

In normal operation the first compressor might require 80 MW of power to drive it and the turbine might generate 200 MW of power. It is preferable to keep the power of the second compressor and expander low relative to the first compressor. The reason for this is that the cost of the first compressor is already included within the cost of the CCGT. The second compressor/expander power will vary with the pressure of the high pressure gas storage 90. The higher the pressure, the larger the power of the second/compressor expander relative to the first compressor. An example might be for a second compressor/expander 24 MW with a nominal power. This would mean that with real losses it would require slightly more than 24 MW of electrical power to charge and on discharge would return slightly less than 24 MW. The table below shows ideal numbers for illustration purposes.

TABLE 2
Modes of Operation for System of FIG. 4

| | | | | Second | |
|---|---|---|---|---|---|
| | | | | Compres- | |
| | Compres- | | Steam | sor or | Net |
| Mode | sor | Turbine | Turbine | Expander | Power |
| Normal | −80 MW | +200 MW | +60 MW | 0 MW | +180 MW |
| Generation | | | | | |
| Discharge | 0 MW | +200 MW | +60 MW | +24 MW | +284 MW |
| (with gas | | | | | |
| burn) | | | | | |
| Charge | −80 MW | 0 MW | OMW | −24 MW | −104 MW |
| Only | | | | | |

From this it can be seen that adding the second stage has the effect of increasing the charge/discharge power of the secondary or sub-system (i.e. storage element) of the hybrid system. However, the main reason for the second stage is that it allows the CCGT (or OCGT) to work at normal design conditions, while allowing the installation of a conventional high pressure CAES (the pressure of which is too high for a normal GT).

Again, it can be seen that most of the same compression and expansion processes are occurring in the CCGT part of the cycle, but there is a time shift between when the compressors work occurs and the turbines work. This means that the storage should have only has a minimal impact on the power generation efficiency. However, in this example only 77% of the mechanical work element is accounted for by the CCGT cycle rather than the 100% of the previous system. Consequently storage losses in the system will be higher than would be expected for the first embodiment, but the overall round trip efficiency of this storage system should be in the region of 75-80%. More importantly this system only requires a small amount of additional power machinery. As with the first embodiment, it will be necessary to size the first motor/generator 15′ for the higher power output.

In this example, the exemplified high pressure CAES is a variable pressure cavern in which the pressure rises as charging progresses, and drops upon discharging. The second compressor and expander preferably comprises positive displacement power machinery, preferably reciprocating rotary or linear machinery including piston based machinery, which is more suited than turbine machinery to higher operating pressures, stop/start operation (whilst maintaining a static pressure difference across the machinery—ie each side of the machine can be kept at a separate pressure without additional valves) and can readily adapt (unlike turbine machinery) to variable pressures (e.g. a reciprocating compressor automatically adapts to different exit pressures without any active control). Thus, where variable pressure air storage is desired in excess of the GT system operating pressures, this is preferably achieved with a second stage of compression/expansion using variable pressure power machinery preferably in the form of reciprocating positive displacement machinery.

The high pressure storage could however be constant pressure gas storage again and such systems are known in the prior art. In this case, a second compressor/expansion stage could be centrifugal based or positive displacement based power machinery, but should always usually be downstream of the first thermal energy storage such that the heat of compression from the first compressor has been partly or fully removed and stored, and so that the second stage does not encounter excessive air temperatures during compression (or need to store sensible heat at such a high temperature). Usually, it will be desirable to store the heat of compression from the second stage in a second thermal energy store for storage and subsequent return on discharge (unless isothermal compression/expansion is employed), although such heat, depending on the amount, could be re-used in other ways (e.g. for steam generation and introduction at the combustor), or, much less preferably, even discarded.

As has been mentioned it should be noted that it may be possible to avoid the need for second motor/generator 74, by also selectively connecting the second compressor and expander by clutch mechanisms to the first motor/generator 15′ (given both compressors would need to operate during charging of the energy storage and both expanders during discharge).

As mentioned above, the TES store may be a simple TES store based on direct thermal transfer. However, FIG. 4a shows ancillary apparatus forming a hybrid storage system that can provide the TES store 41 with “blow-down functionality”, as taught in Applicant's WO2011/104556 mentioned above, and which will now be described.

The high pressure store 41 storing high temperature heat is selectively coupled and decoupled, by means of shut-off valves 604, to one (or two or more parallel) large, lower pressure store 600 in a separate circuit 602 such that lower pressure gas may be circulated by gas transfer apparatus (e.g. pump) 608 between the high pressure store 41 in the second flow network and the lower pressure store 600 in the ancillary circuit 602 so as to relocate the heat temporarily in the lower pressure (and hence lower cost) store 600, which may also be a packed bed or other solid fill store based on direct thermal transfer; apparatus for depressurising the store 41 (before connection to the ancillary circuit) and re-pressurising it (after disconnection from the ancillary circuit) is not shown. The ancillary circuit may require a heat exchanger 606 to reject waste heat.

Accordingly, this first TES system (and any further TES system being based on direct thermal transfer) may be configured for selective connection to, and disconnection from, at least one lower pressure store in a separate circuit (i.e. not in the second flow network) such that the stored thermal energy in such a system may be temporarily transferred by gas transfer apparatus from such a system to the lower pressure store by means of blowing the high pressure store/system down to the lower pressure and then circulating lower pressure gas in the separate circuit between the system and the lower pressure store, there being provided blow down apparatus for isolating and lowering the pressure in such a store prior to transfer to the lower pressure store. For return of the thermal energy, the process is reversed. This procedure (for relocating heat in one or more larger, lower pressure stores) may occur as a batch process, or, as detailed in WO2011/104556 as a continuous process (e.g. during sub-system charge or discharge), if, for example, the first TES system 41 (or the further TES system) comprises a plurality of high pressure stores (e.g. 2, 3, 4 or more) arranged in parallel, such that they may be simultaneously, for example, charging in the second flow network, depressurising (blowing down), transferring to low pressure store in the separate circuit, and re-pressurising (blowing up).

Turning to FIG. 4b, this is a modification of the hybrid of FIG. 4a, where the constant pressure buffer has been replaced with a pressure management system in the form of a two-directional venting system 455 (and where a simple TES system 41 is used).

An alternative pressure management strategy is to provide a pressure relief valve within the TES such that if the flow rates from the first stage, for example on charge, are higher than the second stage the pressure within the first TES can be maintained by venting compressed (ideally cooled) gas to atmosphere. The effect on round trip efficiency will not be significant if this occurs as a very short term-transient. However, it is only available as strategy in one direction. If combined with a high pressure gas buffer that is at a much higher pressure then it may be a good option to combine the two systems. When the pressure is too high in the TES it can be vented to atmosphere and when too low, high pressure gas may be vented into the system from the high pressure gas store. As this system already has a high pressure gas store, it is a preferred embodiment that i) venting can occur from the high pressure gas circuit to the medium pressure gas circuit to raise the pressure and ii) venting can occur from the medium pressure gas circuit to atmosphere to lower the pressure. In this way the gas buffer compensates for under pressures and overpressures.

Venting system 455 comprises high pressure to medium pressure vent valve 457, medium pressure to atmospheric pressure vent valve 456 and controller 458. In this way, the pressure within the TES 41 can be kept constant by selective venting through either valve. If the pressure within TES 41 starts to fall then gas is vented from the high pressure system through vent valve 457. If the pressure within the TES 41 starts to rise, then gas is vented through vent valve 456. The vent valves are controlled by controller 458 that monitors both GT operating conditions, the pressure within TES 41 and connected parts of the system and also provides feedback and optional control signals to the second stage machinery.

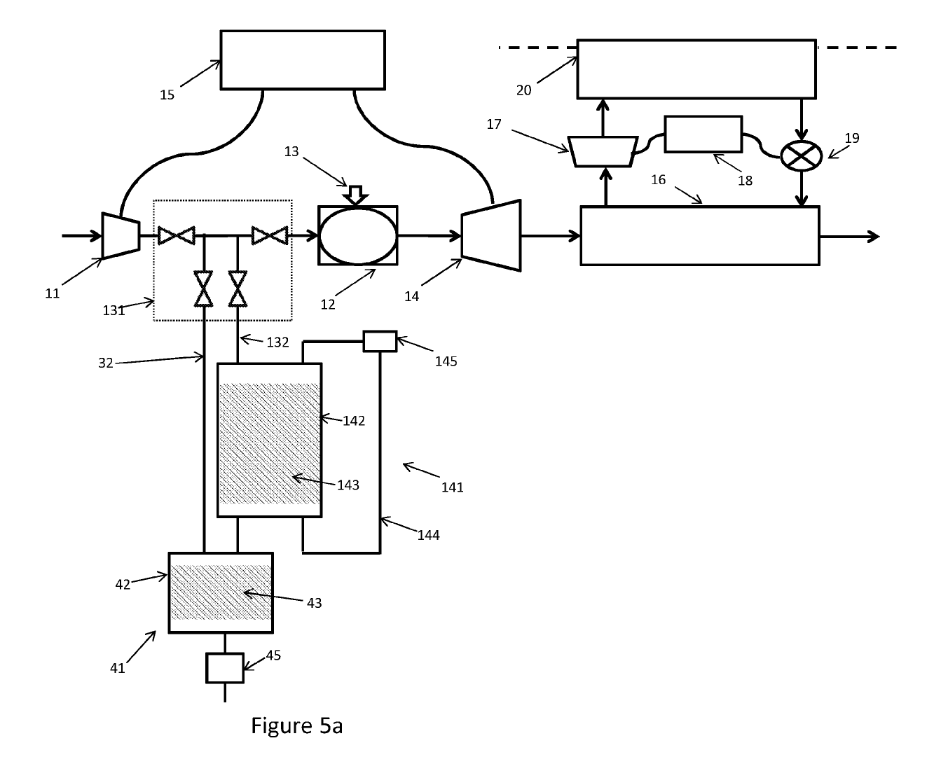

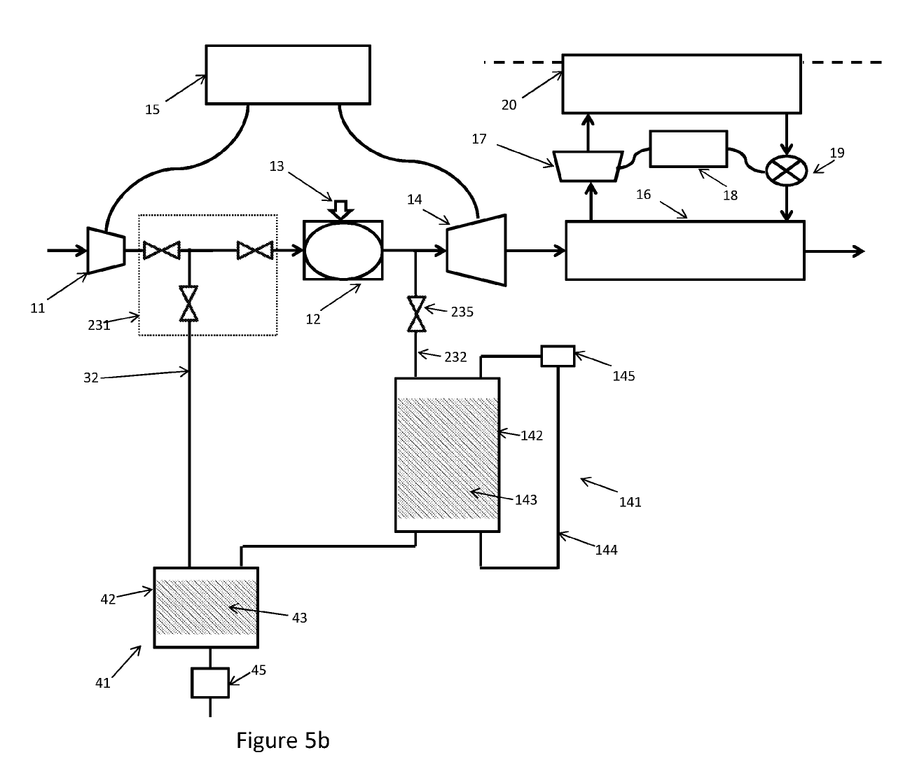

FIGS. 5a and 5b are embodiments illustrating possible respective modifications to the upstream, medium pressure apparatus of the systems of FIG. 3a, 3b or 4a. These embodiments use an additional high temperature heat store 141 that increases the amount of stored energy and reduces or eliminates the requirement to burn natural gas in order to raise the temperature of gas discharging from the sub-system. This device is normally charged with some form of electrical heating using a charging circuit, although other forms of heating are possible.

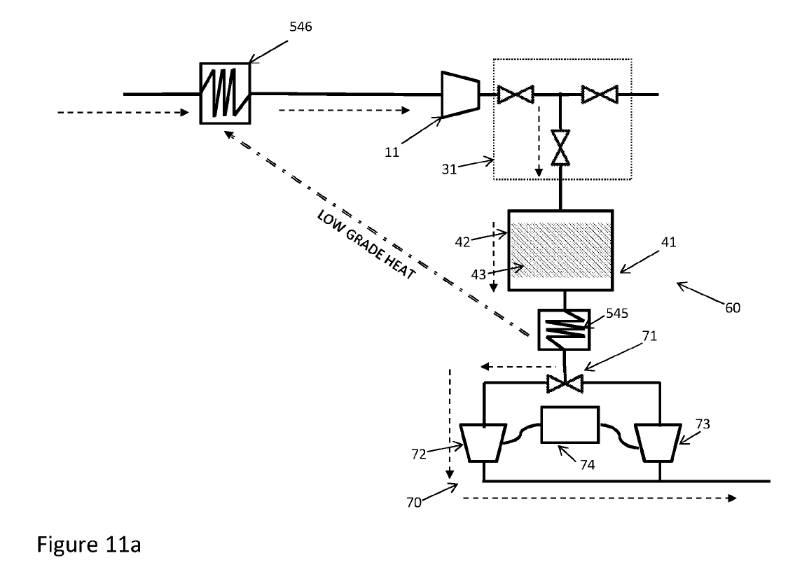

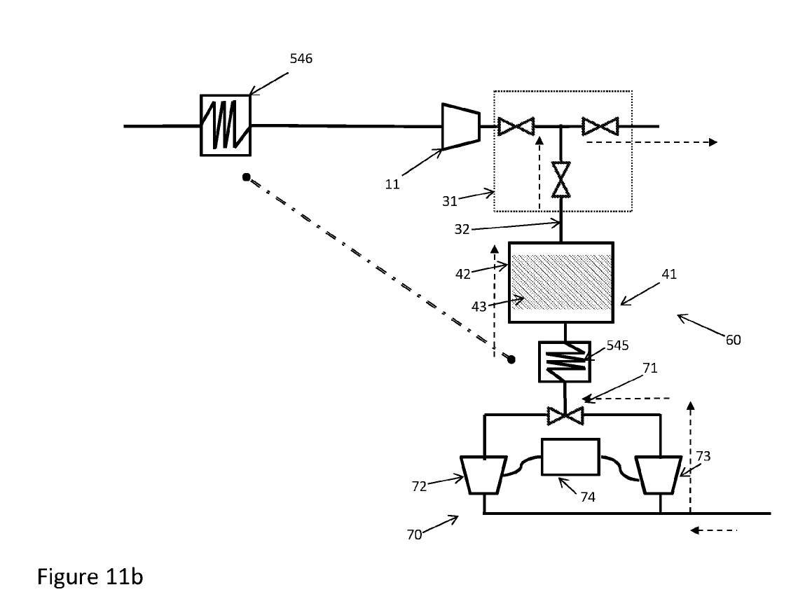

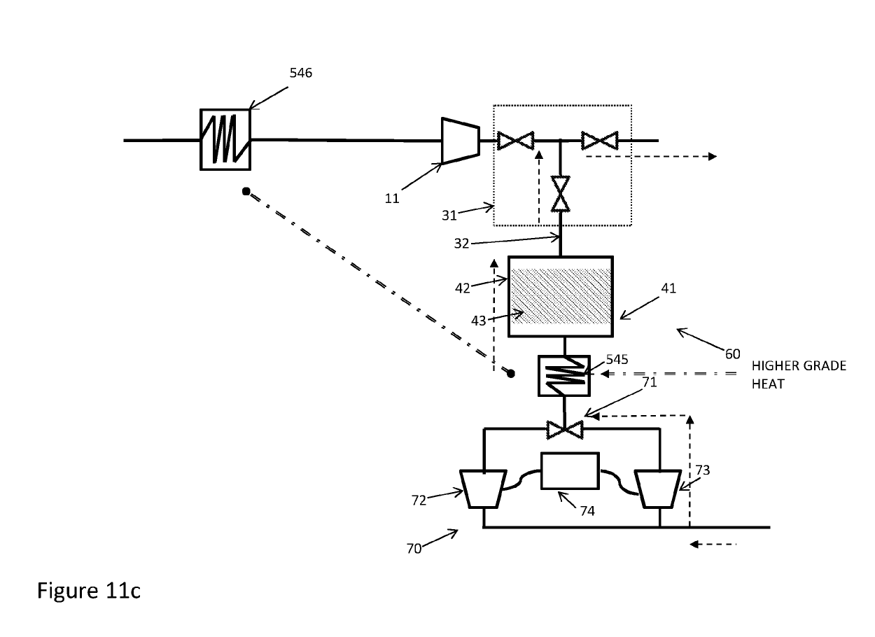

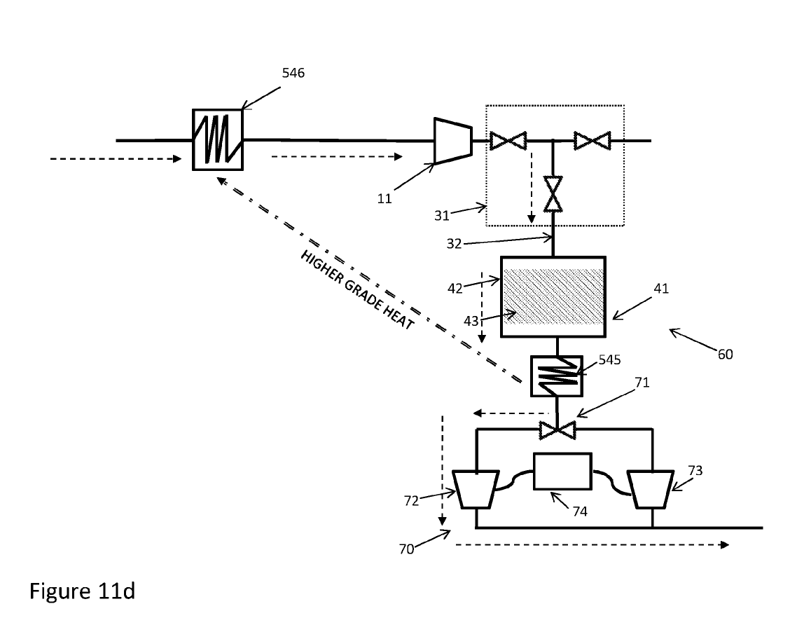

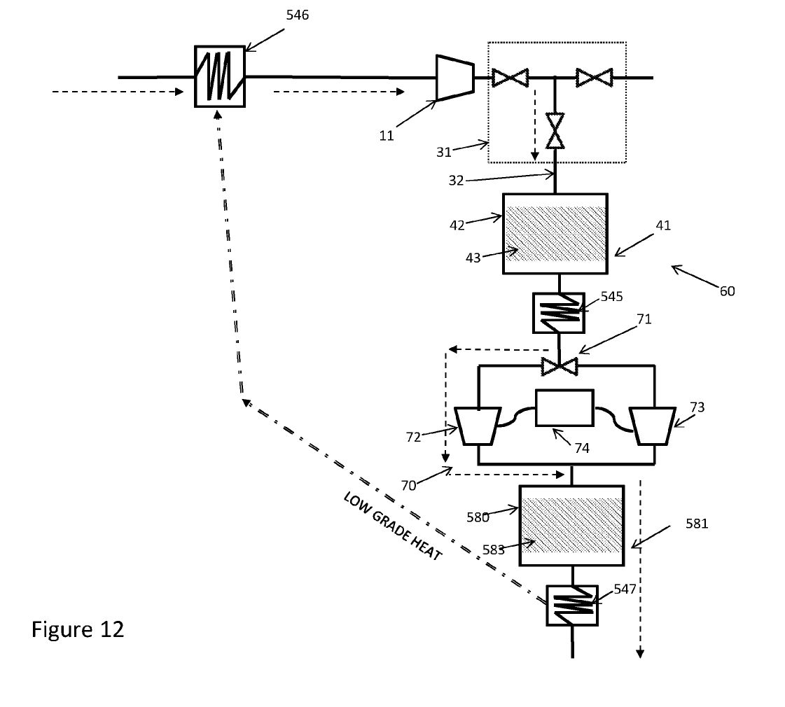

FIGS. 11a to 11d and FIG. 12 depict a number of related modifications that may be made to the hybrid system of FIG. 4b to incorporate pre-heater systems. In particular, FIGS. 11a and 11b depict one modification that may be made to the hybrid system of FIG. 4b to incorporate a pre-heater system, operating in the charging and discharging modes, respectively, while FIGS. 11c and 11d depict a related modification that incorporates a pre-heater system, operating in the discharging and charging modes, respectively.

Turning to FIG. 11a, only part of the CTPGS 60 of FIG. 4b is shown in a charging mode. An additional heat exchanger 546 is added to the air inlet flow that is coupled to heat exchanger 545 (previous 45) via a heat transfer fluid or HTF. First thermal storage system is a simple TES store 41 based on direct thermal transfer as described in FIG. 3 above,

When charging the first thermal store 41, valve 31 diverts hot high pressure gas to the top of the vessel 42 and the gas passes through the thermal media 43 cooling as it progresses. The cooled high pressure gas leaves the first thermal store 41 where it is still above ambient temperature. It is then further cooled in a heat exchanger 545 so that the temperature is close to ambient temperature and heat is transferred to a heat transfer fluid HTF which is coupled to the second heat exchanger 546.

The higher pressure gas leaves heat exchanger 545 and is diverted via valve 71 so that on charging it passes through a second compressor 72 (as shown in FIG. 11a) and on discharging through a second expander (e.g. turbine) 73 (as shown in FIG. 11b). Second compressor 72 and expander 73 are selectively coupled to second motor/generator 74 on a second higher pressure power shaft assembly either separately connected to the grid, or in an alternative embodiment could be selectively coupled to motor/generator 15′ and avoid the need for an additional motor/generator. During charging, the temperature and pressure of the gas is raised by second compressor 72 so that the pressure is approximately equal (but slightly higher) than the pressure in the high pressure gas store 90 or cavern (not shown).

When second stage machinery is provided alongside the gas turbine, the second stage machinery usually needs to be able to match the first stage machinery in terms of gas mass flow rates and be able to respond quickly to any mismatch in such rates. Most compressors or expanders machinery will vary the mass flow that is processed in response to a change in inlet conditions. For example, if you double the base pressure then a reciprocating compressor will process twice as much gas. This can be used to provide a balanced system—ie let the pressure rise until the mass flows through each part of the system matches. However, that is not a controlled system and will not necessarily reach an equilibrium that is at the normal operating condition of the GT.

There are a number of reasons why the temperature of the gas leaving the first thermal store during charging mode is above ambient (or the original baseline store temperature).

The first is that the temperature of gas entering the bottom of the first thermal store from the previous discharge cycle was higher than ambient. This heat is then stored in the thermal store. This additional heat could be the result of machinery losses that have raised the temperature of the gas as it was expanded. They could also be the result of discharging to a slightly lower pressure ratio than the charge cycle.

The second is that thermal losses from the store will tend to manifest themselves by a hotter gas exiting the store from the cold end than the gas that went into the cold end (in the same way that the gas exiting the hot end will be slightly cooler than the gas that originally entered the hot end).

The third is that depending upon the pressure and temperature moisture will start condensing out at about 80 deg C. The heat of condensation for water is very high relative to sensible heat values of air and this heat of condensation will tend to add a large quantity of low grade heat to the store that must also be rejected.

FIG. 11b shows the discharging process, which is the reverse. The hot high pressure gas is then diverted by valves 71 so that it is expanded in expander 73 (with some power generation), before passing back through the first thermal store to receive its stored heat before it enters the combustion chamber and passes through the CCGT.

The last gas inlet temperature when discharging the store (from the cold end) may selectively be raised, during the previous discharge mode, by choosing the degree, if any, at which to discard any of the waste heat generated by the second expander 73. The simplest set-up is to configure the heat exchanger 545 located downstream of the first TES so that they are bypassed or inoperative during the discharge/generation mode, and hence, so that all the (low grade) waste heat from the second expander 73 becomes stored (at a higher “minimum store temperature”) in the first TES system. In the subsequent charging mode, the heat exchanger 545 downstream of the first TES system is then operative to transfer that heat (in effect, waste heat that was temporarily stored in the first TES), for example, via a HTF circuit, to the upstream heat exchanger 546.

FIG. 11c shows a system on discharging where heat exchanger 545 is used to selectively increase the air inlet temperature to the first TES system by supplying at least some heat to the heat exchanger located downstream 545 of the first TES system from an external source; this may therefore allow injection of higher grade heat, e.g. higher grade waste heat from downstream or associated systems operating concurrently in the discharge generation mode.

FIG. 11d shows a system that is identical to 11a, and again in charging mode, where the inlet air is heated to a higher temperature using the higher grade waste heat that was stored during the previous discharge cycle and shown in FIG. 11c.

Use of such a pre-heater system allows more heat to be stored in the first TES system, without a commensurate rise in pressure, which would add to that TES system cost. Hence, the energy density and efficiency of the hybrid system may be improved and in the discharge generation mode, the system is then able to provide a higher temperature pressurised gas to the combustor such that less fuel needs to be supplied to the combustor (the expansion turbine power output need not change). The heat addition may conveniently be by means of a heat exchanger and, because that additional heat stored in the first TES system is discharged through the gas turbine during the discharge generation mode, it does not create a problem of waste heat build-up.

Power Calculations

By way of example only, typical figures for a large gas turbine generation plant are used to quantify the effect of integrating an ACAES with an existing gas power plant, with and without pre-heating, in Table 3 below:—

TABLE 3

| | | | Extra | Extra | Compen- |
|---|---|---|---|---|---|
| | | | heat from | heat from | sated |
| | | | low | higher | Variation |
| Component/ | | | grade heat | grade heat | Mass Flow |
| Mode CCGT | Power | Ambient | eg 343 K | 363 K | at 363 K |
| 2 Gas | MW | 340 | 340 | 340 | 340 |
| Turbines | | | | | |
| 1 Steam | MW | 170 | 170 | 170 | 170 |
| Turbine | | | | | |
| Charging | MW | 554 | 624 | 650 | 515 |
| Normal | MW | 510 | 510 | 510 | 510 |
| Generation | | | | | |
| Discharging | MW | 999 | 999 | 999 | 999 |
| plus | | | | | |
| generation | | | | | |
| Energy | | 100% | 112% | 116% | |
| Density | | | | | |

The table shows a CCGT that consists of two 170 MW gas turbines connected to a steam turbine also of 170 MW power output. Using a pre-heater system such as that shown in FIG. 11a-11d would result in pre-heating of the compressor inlet to 343K and an increase in the power input to 624 MW if the mass flow remained constant. Pre-heating to 363K would increase this figure further to 650 MW again if the mass flow remained constant. However, the Compensated Variation Mass Flow column calculates the power input when the mass flow rate is reduced to compensate for the reduction in density as a result of the higher temperature (assuming 363K). It can be seen that even though the mass flow rate has dropped the power input has actually increased. As can be seen, charging power drops by 7% and energy storage density rises by 16%.

This drop in charging power is as a result of the reduction in mass flow through the second stage machinery. The compression machinery only needs to be sized for the lower flow, but the expansion machinery needs to be sized for a higher return flow to match the turbine. If the same machine is used for both compression and expansion then in normal operation the charging power will be higher than the discharging power. This requires sizing an electric motor/generator for the highest power application and hence the motor/generator must be sized to be about 25% higher power rating than required for discharge. In this case it should be possible to size a motor/generator where the power required on charging and discharging is similar. One point to note is that the discharge time of the system will be lower than the charge time at full power rating. For example it might take 5 hours to charge the system and only 4 hours to discharge it.

The increase in power density is related purely to the increased energy density of the first stage, which increases by approximately 21%. The overall energy density (both thermal stores) of the system increases by 16%.

FIG. 12 depicts an alternative modification that may be made to the hybrid system of FIG. 4b to incorporate a pre-heater system. FIG. 12 again shows only part of the CTPGS 60 of FIG. 4b in a charging mode. In this case, a further heat exchanger collects and redirects heat from a more downstream TES than the first TES system.

In this embodiment, the first thermal storage system is a simple (e.g. particulate bed) TES store 41 based on direct thermal transfer as described in FIG. 3 above, followed by heat exchanger 545, and a second thermal storage system also comprising a simple TES store 581 based on direct thermal transfer is provided downstream of the second stage power machinery 70, with an additional heat exchanger 547 downstream of second store 581 before the compressed gas storage 90. Again, an additional heat exchanger 546 is added to the air inlet flow that is coupled, this time, to heat exchanger 547 via a heat transfer fluid or HTF.

When charging the first thermal store 41, valve 31 diverts hot high pressure gas to the top of the vessel 42 and the gas passes through the thermal media 43 cooling as it progresses. The cooled high pressure gas leaves the first thermal store 41 where it is still above ambient temperature. It is then selectively cooled in a heat exchanger 545 so that the temperature is reduced to a pre-set level that is above ambient and preferably above the temperature at which condensation occurs. Selective heat exchange is able to reject heat to the ambient environment.

The higher pressure and warm gas leaves selective heat exchanger 545 and is diverted via valve 71 so that on charging it passes through a second compressor 72 and on discharging through a second expander (e.g. turbine) 73. Second compressor and expander are selectively coupled to second motor/generator 74 on a second higher pressure power shaft assembly either separately connected to the grid, or in an alternative embodiment could be selectively coupled to motor/generator 15′ and avoid the need for an additional motor/generator. During charging, the temperature and pressure of the gas is raised by second compressor 72 so that the pressure is approximately equal (but slightly higher) than the pressure in the high pressure gas store 90 (not shown). An increase in the temperature of the gas will mean that the mass flow rate through the second compressor will drop, but the work per unit mass processed will increase.

When charging the second thermal store 580 (simultaneously with the first thermal store), valve 71 allows hot high pressure gas to pass into the second compressor for further compression and then it passes through the thermal store cooling as it progresses. The cooled high pressure gas leaves the second thermal store 580, where it is further cooled in additional heat exchanger 547 that is coupled to heat exchanger 546 via an HTF so that the temperature is now to ambient temperature. In this way, the inlet air to the first compressor 11 is pre-heated by heat exchanger 546 with heat from heat exchanger 547.

The gas passes through pipe 91 to high pressure gas storage 90 (not shown).

When discharging the process is reversed. The compressed air leaves high pressure gas store 90 via pipe 91 and is heated as it passes through second thermal store 580. The hot high pressure gas is then diverted by valves 71 so that it is expanded in expander 73 (with some power generation), before passing back through the first thermal store 41 to receive its stored heat before it enters the combustion chamber and passes through the CCGT.

There are a number of reasons why the temperature of the gas leaving the second thermal store is above ambient.

The first is that the temperature of gas entering the bottom of the second thermal store from the previous discharge cycle was higher than ambient. This heat is then stored in the thermal store.

The second is that thermal losses from the store will tend to manifest themselves by a hotter gas exiting the store from the cold end. In the same way that the gas exiting the hot end will be slightly cooler than the gas that entered.

The third is that depending upon the pressure and temperature moisture will start condensing out at about 100° C. This figure is higher as the temperature at which a condensation occurs for a certain quantity of water per kg of air increases with pressure. The heat of condensation for water is very high relative to sensible heat values of air and this heat of condensation will tend to add a large quantity of low grade heat to the store that must also be rejected.

In the above pre-heater systems of FIGS. 11 and 12, the use of a HTF circuit to link the relevant pair of heat exchangers is desirable, but they could also be co-located in a counter-current heat exchanger for direct heat transfer, if system configuration allows this.

FIG. 5a shows the medium pressure stage of either FIG. 3a, 3b or FIG. 4a, but where there is a packed bed for the first thermal store 41. Selector valve 31 is replaced with selector valve 131 which has the same functionality as 31, but where, upon charging, the flow is diverted through diffuser/effuser 32, but upon discharging, the flow may either be returned through diffuser/effuser 32 or else diverted through high temperature store 141 and then effuser 132.

High temperature thermal store may, for example, internally resemble a firebrick regenerative chamber as used in the steel making industry. These normally operate at temperatures of around 1250° C. High temperature store 141 consists of high temperature vessel 142 enclosing high temperature media 143. High temperature vessel 142 needs to be a pressure vessel as it will see that same pressures as thermally insulated vessel 42. Electrical heating device and fan 145 is connected to circuit 144, which enables warm gas to be drawn from the bottom of high temperature vessel 142, passed through electrical heating device and fan 145 and heated to high temperatures, possibly in excess of 1250° C., before being passed through high temperature media 143. High temperature media cools the hot gas and is heated up creating a hot thermal front that moves from the top of the store to the bottom. As has been explained, heating may be electrical or by other means. If electrical it may be resistance heating, of by electric plasma or by induction or by other means.

In an alternative embodiment (not illustrated) electric heating means are located throughout the high temperature media 143, so that heating is direct to the media without the need for fans or circuit 144.

In FIG. 5a, upon discharge compressed air passed through first thermal store 41 and depending upon the switching of selector valve 131 it may pass through high temperature store 141. As the gas passes through high temperature store 141 it is further heated to a temperature that may be high enough that no gas needs to be burnt in the combustor. Alternatively, some fuel gas may be burnt to raise the temperature of the incoming air so that it meets the requirements of the turbine and steam parts of the cycle.

FIG. 5b is a variation on FIG. 5a in that the high temperature store 141 is now connected directly to the turbine 14 via selector valve 235 and effuser 232. In this way hot gas is fed directly into the turbine without any combustion or the requirement to pass through the combustion chamber.

The flow pathways of the respective primary system and sub-system, including their interconnections, may be controlled by separate, suitably positioned valves of any suitable type in order to achieve the desired operational modes. In the above embodiments of FIGS. 3a and 3b, FIGS. 4a and 4b, and FIG. 5a, that functionality is conveniently achieved at a single location, by a single multi-flow selector valve arrangement, while FIG. 5b shows two selector valves.

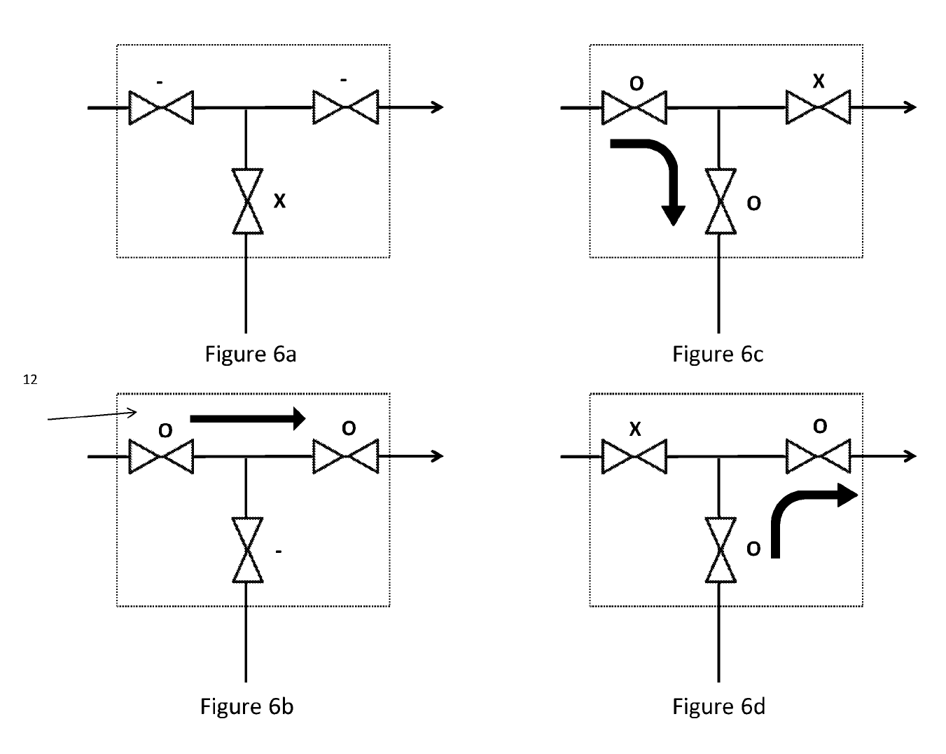

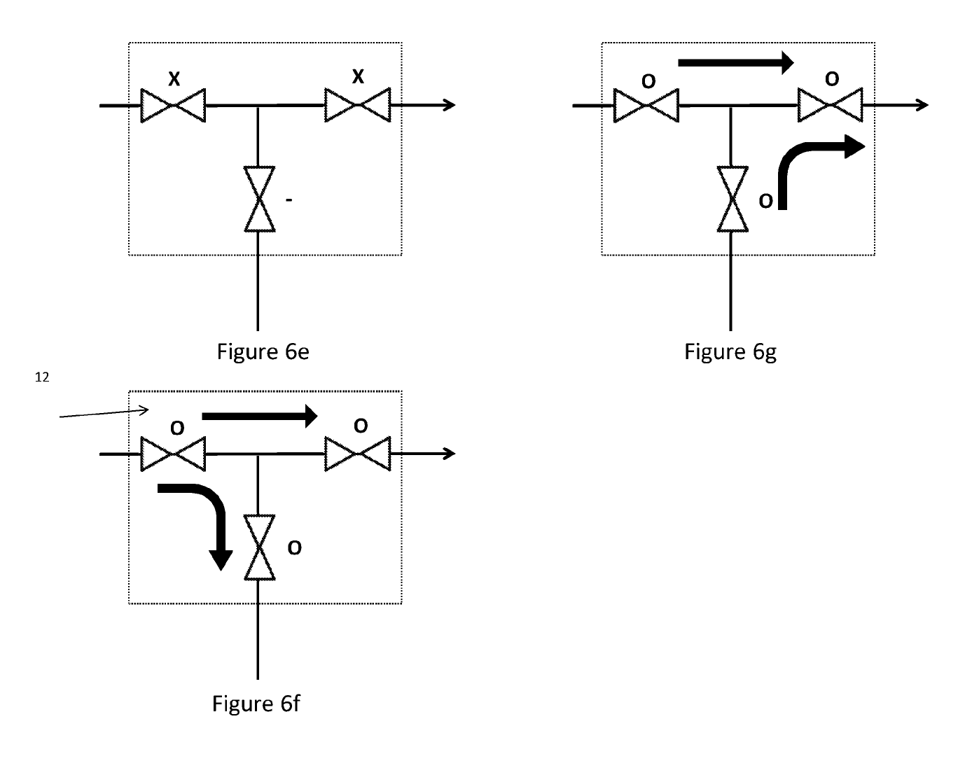

FIGS. 6a to 6g illustrate various respective configurations for the single flow selector valve arrangement in different operational modes.

FIG. 6a shows the flow selector valve in a shut-off configuration where the system is not in operation and the store side valve is in a closed configuration and the other two valves may be open or closed.

FIG. 6b shows the flow selector valve in a generation only mode where the compressor side valve and turbine side valves are open and the store side valve may or may not be open. The reason that the store side valve may or may not be open is that if the compressor and turbine mass flow rates of air are equal then there is no net flow into or out of the store even in the valve is open.

FIG. 6c shows the flow selector valve in a charge only mode where the compressor side and store side valves are open and the turbine side valve is closed.

FIG. 6d shows the flow selector valve in a discharge only mode where the compressor side valve is closed and the store side and turbine side valves are open.

FIG. 6e shows an alternative shut off configuration where the compressor side and the turbine side valves are closed and the store side valve may be open or closed.

FIG. 6f shows a configuration where there is some generation and charging occurring at the same time. All of the valves are open.

FIG. 6g shows a configuration where there is some generation and discharging occurring at the same time. All of the valves are open.

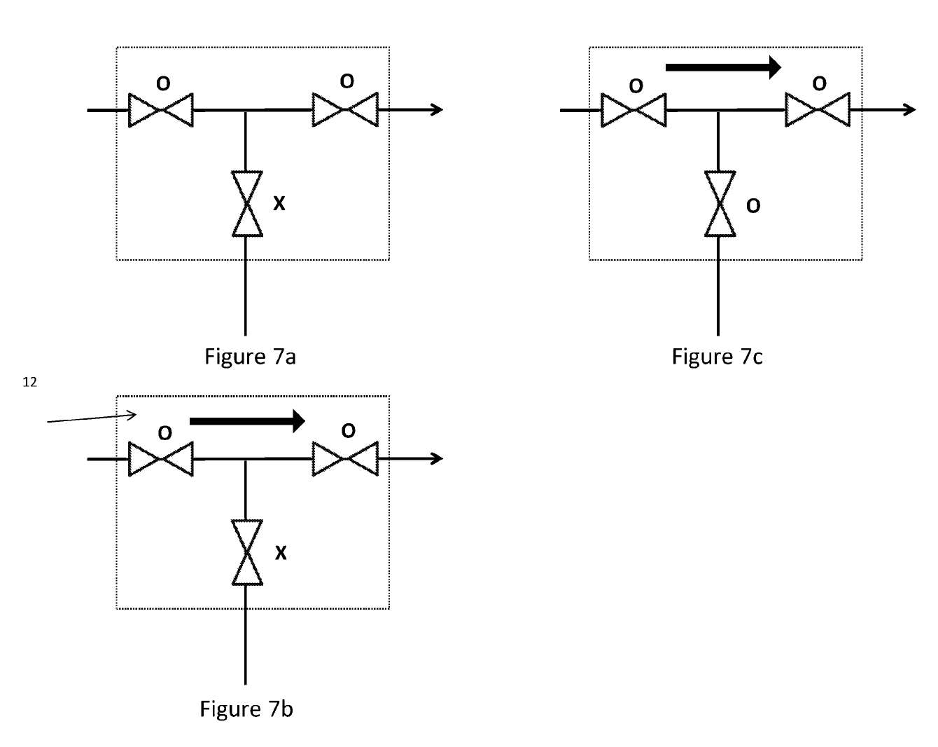

FIGS. 7a to 7c shows a way of starting up the system using alternative configurations of the flow selector valve arrangement. This is important because the intention is to fit this to a conventional power generation unit and the start-up/shut down should not interfere with that operation. Furthermore, starting of GT's is a well understood problem so that it is beneficial that the existing understood practices can be used.

In FIG. 7a the system starts in a shut-off configuration where the store side valve is in a closed configuration and the other two valves are open.

In FIG. 7b, the system starts up in normal gas turbine generation mode where the compressor side valve and turbine side valves are open and the store side valve is shut.

In FIG. 7c the system is now generating normally and the store side valve can now be opened. If the compressor and turbine mass flow rates of air are equal then there is no net flow into or out of the store even in the valve is open. It should also be noted that when there is no flow within the system then all parts of the store will be at the same static pressure.

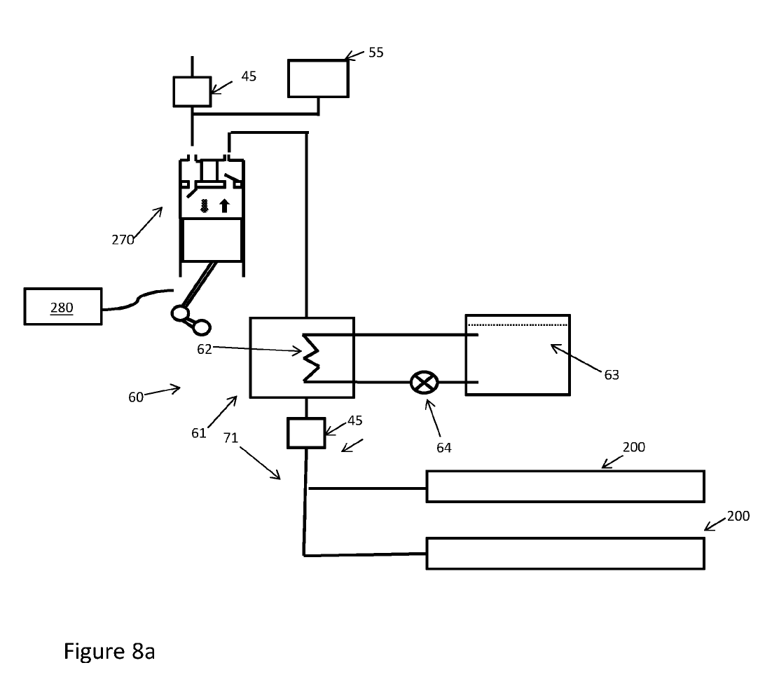

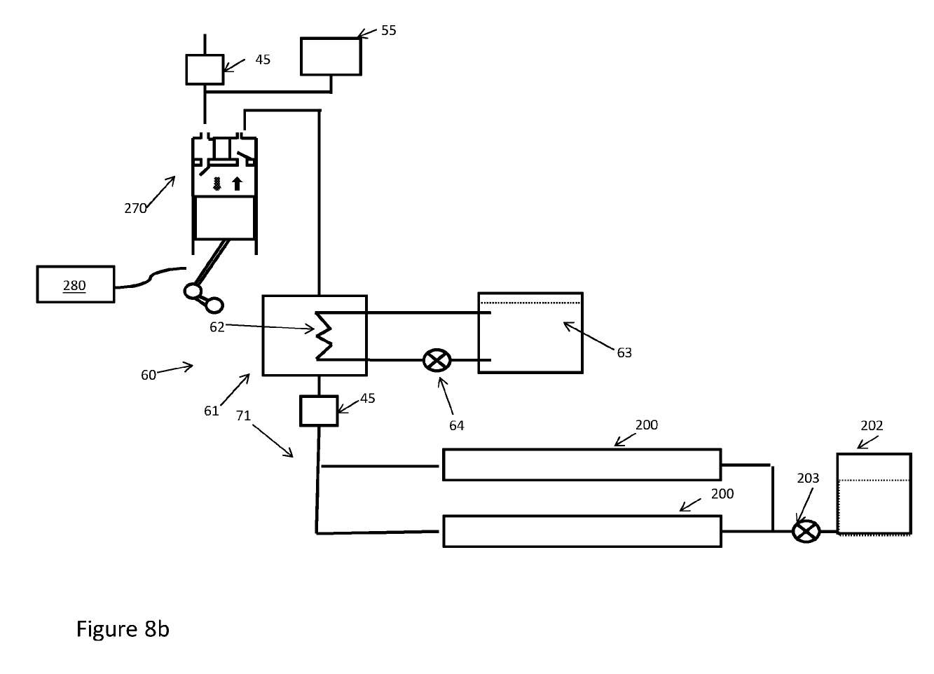

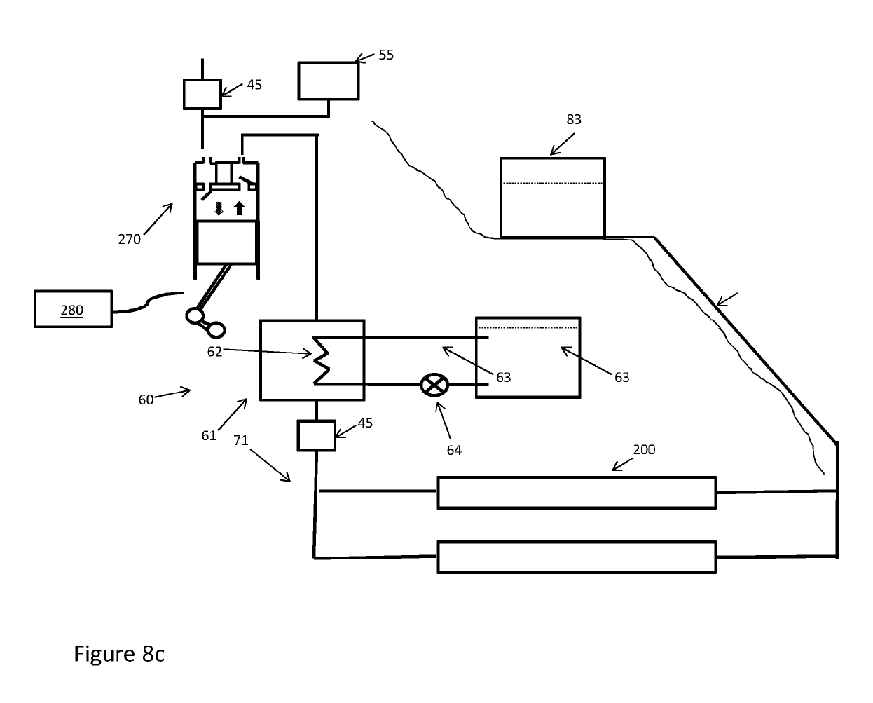

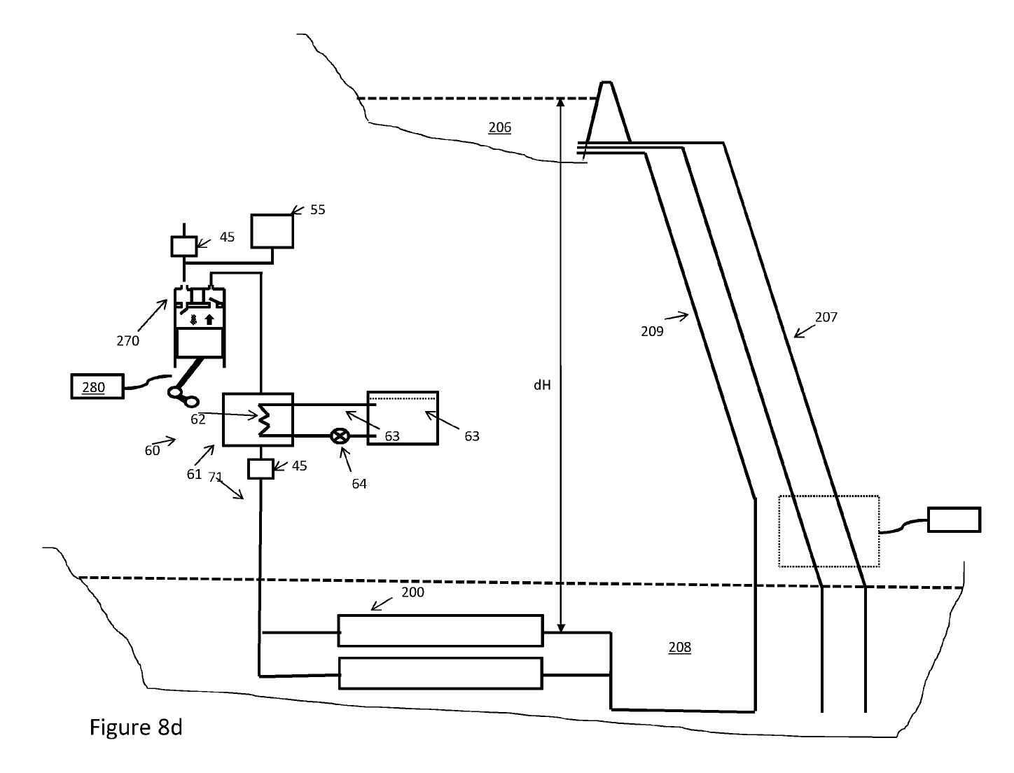

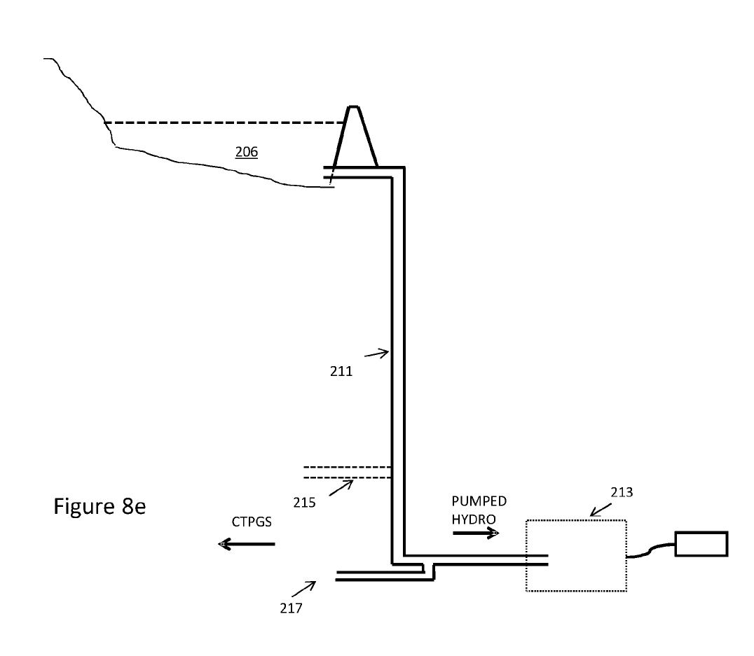

FIGS. 8a to 8d are embodiments illustrating possible alternative variants of the downstream, higher pressure apparatus of the system of FIG. 4a, starting from the heat exchanger 45 (associated with the first thermal store). They each comprise a single, reversible, reciprocating, positive displacement (e.g. linearly reciprocating piston) power machine 270 that is capable of acting as both a second compressor and second expander for providing the second, higher pressure stage power machinery. Reversible power machine 270 is operatively associated with motor/generator 280. The power machine 270 and motor/generator 280 may both be variable power. Conveniently, a positive displacement based machine may be switched rapidly from a compression mode to an expansion mode of operation, merely by changing valve timing, as taught in Applicant's WO2012/013978. Alternatively, separate positive displacement machines may be provided to conduct the respective (adiabatic or isentropic) expansion and compression functions; multiple single function or multiple reversible machines may be provided to cover respective pressure ranges.

In FIGS. 8a to 8d, the second thermal energy storage system 60 is again based on an indirect transfer using a heat exchanger 62, so as to avoid the need to build a store with direct heat transfer capable of withstanding the very high pressure compressed gas. The heat exchanger 62 may be linked in a circuit to, for example, a single stratified liquid tank 63 containing the circulating heat transfer liquid as thermal storage medium. As the pressure ratio for any second stage compression/expansion is much lower (e.g. 1:2 to 1:4 for example), less heat of compression will require storage such that the thermal store is unlikely to need to operate above 250° C. or even 200° C., and hence, liquid thermal storage may be used.

In FIGS. 8a to 8d, instead of a cavern, the compressed air store comprises above-ground pressure vessels in the form of one or more high pressure steel pipes 200.

In FIG. 8a, the high pressure steel pipes store gas at a varying pressure that increases upon charging and decreases upon discharging, as provided by the positive displacement machine(s).

In FIG. 8b, the embodiment is a similar system to FIG. 8a, but the steel pipes 200 are kept at a constant pressure by balancing with a suitable fluid, such as water. In the case of water as the fluid, this involves the addition of a water tank 202 and an additional pump 203. It should be noted that the pump 203 is ideally reversible and the electricity generated or use is fed back into the system. In the configuration shown, the level of the water in the water tank 202 is at a similar altitude to that of the aboveground pressure vessels. A similar altitude would normally be within 30 m or 40 m. A disadvantage of this system is that the while the work of charging the aboveground pressure vessels requires work, the pumping out of water from high to low pressure generates significant “back work”. This has the effect of reducing the overall energy density of the system in that, upon discharge, work is required to pump the water back up to high pressure. The result of this is that the system will require a greater volume of aboveground pressure vessels and large water pumps and large water tanks.

It should be noted that as the pressure within the pipes increases, the amount of “back work” as a proportion of cycle work decreases. Furthermore the amount of water required and the amount of space required both drop. This means that if the pipes are at much higher pressures, say 100 bar, then the amount of space for the gas pipe is approximately 20% of that which would be required at 20 bar, furthermore the amount of water required to balance the system is also reduced by a factor of 5.

The embodiment of FIG. 8c is similar to FIG. 8b, except that the water tank 83 is at a significantly higher altitude (e.g. >50 m, or even >100 m) than the aboveground pressure vessels 200. Ideally the difference in altitude matches the required pressure, so that there is no requirement to include any additional reversible water pump. Furthermore the work of raising the water to the higher altitude adds to the energy density of the system. For every 10 m difference in altitude a pressure difference of 1 bar can be balanced; so in this case if the difference in altitude was 400 m, the aboveground pressure vessels could be at approximately 40 bar.

The embodiment of FIG. 8d shows a system similar to FIG. 8c, but integrated into a pumped hydro plant. This could be a new pumped hydro plant or integrated into an existing one. In this Figure, the pumped hydro plant has three pipes that feed water from the higher reservoir 206 to the lower reservoir 208. Two of the pipes 207 are maintained for pumped hydro use only and the third 209 is used for pressure balancing the hybrid system. The amount of the plant used for the new system is a choice, and in some circumstances, could fully replace the pumped hydro system. In this case, it would resemble the system in FIG. 8c. Alternatively it is possible that with suitable valves both systems could share the pipes depending upon the mode of operation required.

FIG. 8e shows an alternative retrofit of a pumped hydro plant (eg Dinorwig), with a single water channel in the form of a near-vertical tunnel 211 between the top lake and the generating plant 213. To tap in to such a system, this tunnel could be linked to the current CTPGS system by a dedicated fluid tapping 215, for example, with the compressed air store at least of the CTPGS located at a selected height difference from the top lake (i.e. selected pressure difference) or the water connection to the hydro plant could be used to provide a convenient tapping point by means of a spur 217 from the existing system. As the current system uses the water column of the pumped hydro plant simply as a very large standpipe, there is no need for this system to have any interaction with the lower lake and the functionality of the pumped hydro plant may be unaffected.

By way of example, the UK has a pumped hydro plant at Dinorwig where the difference in altitude is approximately 600 m, so integrating into this system would allow pressure vessels that are designed for 60 bar. The water infrastructure is already present in the form of the ducts that carry the flow to the hydro turbines. The installation of a CCGT plant on site then provides some base or intermediate load in addition to the hydro storage (Peak Load operation) and the CAES component becomes less space-invasive as the pressurised water tankage is already present. Further, the above-ground pressure vessels could be positioned on one or more (level) terraces arranged at different respective heights below the higher reservoir, such that different constant pressure gas storage may be provided associated with the respective height differences between the terraces.

One of the issues with man-made pressure vessels in the form of gas pipeline is that they require a significant area of land. One embodiment would involve the pressure vessels being submerged in the lower reservoir. This has a number of advantages as follows. In the event of a failure of the compressed air vessel/pipeline the surrounding water will act as a significant energy absorber. This in turn allows for smaller safety factors and hence lower cost pressure vessels. The hydrostatic level of the water may offer a small reduction in the loads experienced by the vessel and hence reduced material requirements. The pipes are all maintained at a uniform temperature so thermal expansion issues are greatly reduced. The compressed gas within the pipes is also kept at a uniform temperature. There is no visual impact of the pipeline/pressure vessel on the scenery. If the entire pumped hydro system is used then the lower reservoir will not see any change in level during operation, there is no possibility of damage to marine species and in fact the submerged vessels may offer additional habitat for certain types of marine creatures. It has been noted that the changes in level associated with pumped hydro can have a severe impact on fish populations. There would still be changes in level for the upper reservoir, but this would reduce or negate the effects on the lower reservoir.

An alternative embodiment would involve the CCGT being located some distance away from the pumped hydro plant and only being connected to the pumped hydro plant by a high pressure pipeline. In this way the part or all of the high pressure connection pipeline can also be the storage vessel. This may have particular relevance if the pumped hydro plant is located in an area where development is restricted or there are limited supplies of gas.

FIGS. 9a to 9d show alternative methods of mechanically coupling the one or more compressors and the one or more turbines of the gas turbine to various power shaft assemblies to allow them to be driven by, and to drive, each other, or associated motors and/or generators, via those assemblies, respectively, depending on the modes of operation.

As described earlier, FIG. 9a shows a simple, single power shaft assembly formed from a compressor 11 and a turbine 14 of the modified gas turbine unit detachably coupled in-line with clutches 101 to a double-ended motor/generator 15′ located between them.

Alternatively, FIG. 9b shows a line shaft arrangement 300 comprising a main shaft powered by a main motor/generator (usually a large synchronous motor/generator) with clutches axially disposed along the shaft for coupling, with or without gearing, to additional compressors and turbines 302 (e.g. both low and high pressure/temperature variants) and pumps 304. These machines can all be clutched in and out of operation with the line shaft. Although more lossy than direct couplings, such a line shaft arrangement 300 may be more appropriate where a variety of power machinery needs to be brought online in the different operating modes, or in response to varying demand. Other motor/generators may be provided on other line shafts, which may also be clutched in to the main line shaft and these could, for example, be more sophisticated variable power generators for use at start-up to synchronise the main motor/generator, which may be a simple fixed speed synchronous device. In this example, the variable speed motor/generator 306 would bring the whole system up to speed so that it could be synchronised. The main motor/generator might have sufficient capability for normal generation and the variable speed device would then be used for peaking mode where maximum power output was required. If OCGT's and CCGT's are stopped while hot, there can be a significant temperature difference inside the GT that can lead to issues with alignment of shafts and blades. Consequently, it may desirable to be able to keep the system spinning at low speed with a variable speed motor/generator rather than actually stopping it. Generally variable speed motor/generators are more expensive than fixed speed devices.

FIG. 9c shows an alternative embodiment 310 where each of the separate units of power machinery is coupled on an individual power shaft to a specific motor, generator or motor/generator, and these are connected to a grid such that the power machinery is in fact electrically coupled to each other. Thus, in this figure, first compressor 314 is directly coupled to a motor 312 by power shaft 313. The motor 312 is connected via cable 311 to electrical grid 321. First turbine 316 is directly coupled to generator 315, pump 318 is coupled to motor 317 and generator 319 to steam pump 320. These components comprise the main power generation units of a CCGT. Second stage compressor/expander 322 is directly coupled to a motor/generator 323 that can function as either a motor or a generator. It is assumed that suitable controls for starting and stopping these devices are in place and that the motor, generators and motor generators may be synchronous, induction, fixed speed, variable speed or other suitable type of motor. The advantage of this configuration is that at large sizes electrical machinery is highly efficient, in the region of 98%, versus a mechanical coupling that might be 99% efficient and a direct shaft that approaches 100%. Consequently there will be power losses from the electrical coupling, but they are likely to be relatively low versus the ability to avoid the large mechanical forces that are likely to occur in mechanical clutches. Furthermore the use of a single electrical machine with specific units means that they can be built in a modular fashion and hence the capacity of the system can be varied by adding units rather than making them bigger.

FIG. 9d shows a similar example to FIG. 9c, where a gas turbine might comprise 5 standard compressor units 332 directly coupled on power shafts to individual motors 331 arranged in parallel and 3 standard turbine units 334 directly coupled on power shafts to individual generators 335 in parallel, with a common gas path and single combustor 12 fed with fuel supply 13.

Flow selector valve arrangement 31″ allows the flow from the compressors 332 to be diverted to first thermal store 41 (not shown) (for charging) or from first thermal store 41 to combustion chamber 12 (for discharging) or possibly a mixture from both compressors 331 and first thermal store 41 to combustion chamber 12 (for discharging), or a combination of the above. The selector valve 31″ may simply connect all three areas (compression, storage and combustion) and have simple shut-off or non-return valves so that flow cannot go in the wrong direction through either the compressors or the combustor. In this way it is possible to configure a system where if there is any mismatch in flow between the compressor(s) and the turbine(s) then the system is able to automatically balance by allowing either flow in or out of the first thermal store 41 to balance the system.

It should be understood that the gas flow path should be optimised to minimise direction changes of the gas, so that the compressors and/or turbines might be configured in a circular arrangement with the gas flow all feeding in to or out of a central gas flow path.

Turbine selector valve arrangement 333 allows the flow from the combustor 12 to be diverted to one, two or three of the turbines. The turbine selector valve 333 may have simple shut-off or non-return valves so that flow cannot go in the wrong direction through the turbines.

Motors 331 and generators 335 are connected to electrical grid 337 by connections 336 and 338. With this system of electrical coupling of the power machinery, it is then possible to add additional compressors to boost the charging power of the system, so different modes may be achieved as shown in the following examples:
i. in a generating mode the system might use 3 compressors and 3 expanders
ii. in part power generation part storage mode the system might use 5 compressors and 3 expanders
iii. in a pure storage mode the system might use 5 compressors
iv. in a partial discharge mode only 1 expander is used

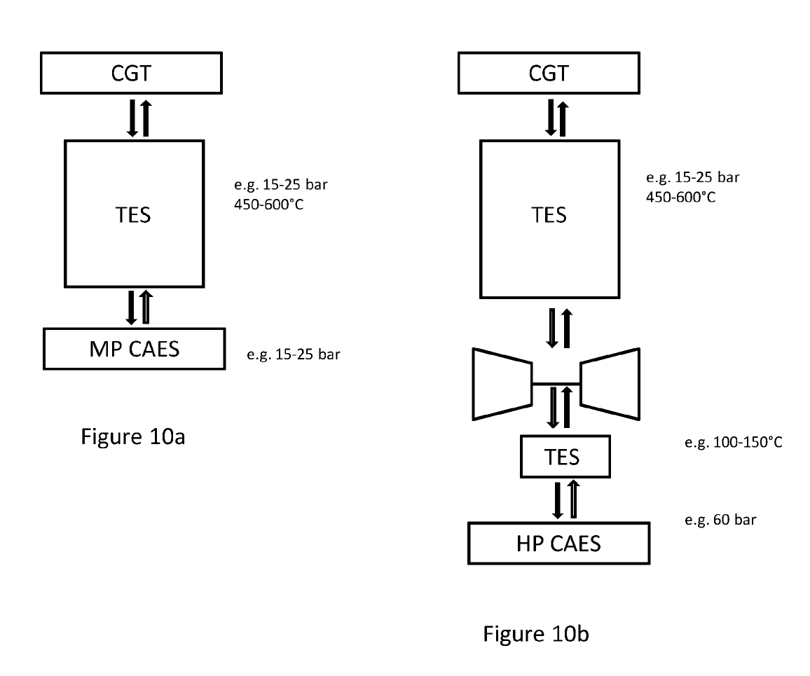

FIGS. 10a and 10b are schematic flow diagrams of two preferred hybrid CTPGS. FIG. 10a shows a hybrid in which no further compression/expansion stages are present, and hence, where the TES and CAES are configured to receive compressed gas roughly at the temperature and pressure it leaves the compressor outlet (conveniently referenced as MP medium pressure); the CAES will be a constant pressure or nearly constant pressure CAES. As indicated above, a packed bed thermal energy store is highly preferred for this task due to the high pressures and temperatures involved.

FIG. 10b shows a hybrid comprising more conventional higher pressure (HP) CAES, and thus, includes at least a second compression/expansion stage. If that stage conducts adiabatic expansion and compression, a further low temperature (but high pressure) TES is required, which may be a solid fill thermal energy store or a heat exchanger linked to a liquid thermal store. The higher pressure CAES may be a constant pressure or variable pressure CAES. Where variable pressures are involved, positive displacement power machinery is preferred.

The embodiments described above may be constructed as new build OCGT's, CCGTS or other derivatives. However, it is also possible to retrofit this to existing plant.

The modification to an existing CCGT will normally involve:

(i) replacement (and eg onward sale) of the existing gas turbine and upgrade of the generator with a similar sized gas turbine where the compressor and turbine are selectively coupled to an upgraded motor/generator and a selector valve is added between the compressor output and the combustion chamber.

(ii) replacement (and eg onward sale) of the existing gas turbine (but not generator) and replacement with a smaller sized gas turbine where the compressor and turbine are selectively coupled to the existing generator (assuming it can also be operated as a motor/generator) and a selector valve is added between the compressor output and the combustion.

(iii) modification of the existing gas turbine and upgrade of the generator so that the compressor and turbine are selectively coupled to an upgraded motor/generator and a selector valve is added between the compressor output and the combustor.

As the CCGT will almost certainly not be built on a site that has suitable geology or geography, it is likely that the high pressure gas storage part of the system will consist of man-made pressure vessels. These would normally be in the form of high pressure gas pipeline material.

If a higher power output is selected it may be necessary to also upgrade transformers and switchgear to meet the increased load. Version ii) above would avoid this requirement as the power output of the gas turbine has been decreased so that it is the same as before when in discharge mode.

With respect to existing OCGT's, the system can potentially improve the apparent efficiency of the OCGT and also boost the power output of the existing plant. The reason for this is that the compressor energy would normally be driven from the electricity grid, which means that the ‘fuel’ input for this part of the cycle is not directly correlated to the price of gas. If off-peak power is very low cost relative to gas then it will effectively ‘lower’ the fuel cost of the OCGT and improve the apparent efficiency.

The modification to an existing OCGT may be the same as for the CCGT, but there may be an additional option to re-use existing equipment and generator, but to reduce the amount of fuel burnt when in discharge mode such that the power output is the same as for the normal operation mode.

While the present invention has been described in detail with reference to certain preferred embodiments, other embodiments of the invention are possible. Therefore, the scope of the appended claims should not be limited to the description of the preferred embodiments contained herein.

1. A hybrid combustion turbine power generation system (CTPGS) comprising:
a primary, combustion turbine based system,
the primary system comprising one or more power shaft assemblies comprising at least a first generator or motor/generator, at least a first compressor and at least a first expansion turbine operatively associated with the one or more power shaft assemblies, and at least one combustor configured to feed the at least first expansion turbine,
wherein the primary system comprises a first flow network allowing outlet air from the at least first compressor to pass successively downstream to the at least one combustor for combustion and the at least first expansion turbine for expansion, respectively,
wherein the primary system is modified by integration of:
an adiabatic compressed air energy storage (ACAES) sub-system,
the sub-system comprising at least one compressed air store and at least a first thermal energy storage (TES) system for removing and returning thermal energy to the compressed air upon charging and discharging the store, respectively,
wherein the sub-system comprises a second flow network allowing outlet air from the first compressor to pass, upon charging, via the TES system to the at least one compressed air store, and to pass, upon discharging, back to the at least one combustor and/or first expansion turbine, via the TES system,
wherein the hybrid CTPGS further comprises flow valve arrangements and mechanical coupling arrangements so configured as to provide the necessary flow and mechanistic connections to allow the hybrid CTPGS to be operable in at least the following modes of operation:—
(i) a power generating first mode in which the hybrid CTPGS produces power and the sub-system is not discharging; and,
(ii) a power generating second mode in which the hybrid CTPGS produces power and the sub-system is discharging.

2. (canceled)

3. (canceled)

4. A hybrid CTPGS according to claim 1, which is operable in any one or more of the following modes:
(i) a sub-mode of the power generating first mode in which the sub-system is also not charging and all of the compressed air from the first compressor is directed towards the combustor and expansion turbine;
(ii) a further sub-mode of the power generating first mode in which the sub-system is self-charging such that some of the compressed air from the first compressor is directed towards the sub-system and some is directed towards the combustor and expansion turbine;
(iii) a charging-only third mode in which the expansion turbine is inactive and the first compressor is electrically driven by the motor/generator, or a separate motor, to charge the sub-system, all of the compressed air from the compressor being directed towards the sub-system; and
(iv) a sub-mode of the power generating second mode in which the first compressor is inactive and all of the compressed air is supplied to the expansion turbine by discharging the sub-system.

5-7. (canceled)

8. A hybrid CTPGS according to claim 1, wherein the first flow network is provided with a single connection to the second flow network located between the first compressor and combustor, at which connection flow is optionally controlled by a flow selector valve arrangement.

9-12. (canceled)

13. A hybrid CTPGS according to claim 1, wherein the at least one compressed air store is located in the sub-system downstream of at least a second, higher pressure compression/expansion stage of power machinery so as to provide a higher pressure compressed air store in which compressed air can be stored at an operating pressure significantly higher than the compressor outlet pressure of the primary combustion turbine based system.

14. A hybrid CTPGS according to claim 13, wherein the at least one higher pressure, compressed air store is a variable pressure compressed air store, optionally selected from high pressure pipes, or a high pressure cavern.

15. A hybrid CTPGS according to claim 13, wherein the at least one higher pressure, compressed air store is a constant pressure compressed air store, optionally selected from pressure balanced high pressure pipes, or a pressure balanced cavern.

16. (canceled)

17. (canceled)

18. A hybrid CTPGS according claim 13, wherein the second, higher pressure, compression/expansion stage comprises positive displacement power machinery.

19. A hybrid CTPGS according to claim 18, wherein the positive displacement power machinery comprises linear reciprocating power machinery that is reversible so as to be capable of acting as both a compressor and an expander, as required, during charging and discharging, respectively.

20. A hybrid CTPGS according to claim 13, wherein the at least one compressed air store is a variable pressure store and the second, higher pressure, compression/expansion stage comprises variable pressure and/or variable mass flow power machinery, where the variable mass flow may be actively controlled.

21-23. (canceled)

24. A hybrid CTPGS according to claim 1, wherein the first TES system and/or any further TES system comprises a direct TES comprising at least one thermal energy store forming part of the second flow network and through which the compressed air has a flow path for direct exchange of thermal energy to a thermal storage medium contained within the thermal energy store.

25. (canceled)

26. (canceled)

27. A hybrid CTPGS according to claim 1, wherein the first TES system is configured to withstand a maximum operating temperature within the range of 450-600° C.

28-30. (canceled)

31. A hybrid CTPGS according to claim 24, wherein the first TES system comprises a direct transfer, sensible heat store incorporating a solid thermal storage medium disposed in respective, downstream, individually access-controlled layers.

32-40. (canceled)

41. A hybrid combustion turbine electricity storage and power generation system comprising:
(i) a combustion turbine based system comprising a first compressor, at least one flow controller, a combustor and an expansion turbine arranged respectively downstream of each other; and,
(ii) an energy storage system integrated with the combustion turbine based system by means of the at least one flow controller, the energy storage system comprising at least a first thermal energy storage TES system for removing and returning thermal energy to compressed air passing through it upon charging and discharging the TES system, respectively,
wherein the energy storage system is configured:—
to store thermal energy in a charging mode in which air is compressed in the first compressor and passes through the first TES system so as to heat the store;
to retrieve thermal energy in a discharging mode in which air passes back through the first TES system so as to cool the store;
wherein the hybrid system is configured to be operable in the following generation modes:—
(a) a normal generation mode in which the energy storage system is not operating in the above charging or discharging modes, and the flow connectors are configured to direct heated, pressurised outlet air from the first compressor to the combustor for combustion and then to the expansion turbine for subsequent expansion to produce electrical power; and,
(b) a discharge generation mode in which the energy storage system is operating in the above discharging mode, and the flow connectors are configured to direct heated, pressurised air from the first TES system to the combustor for combustion and then to the expansion turbine for subsequent expansion to produce electrical power; and,
wherein a pre-heater system is provided upstream of the first compressor with respect to the charging mode, and is configured in the charging mode to preheat air entering the first compressor so as to increase the temperature of air entering the first TES system.

42. A hybrid system according to claim 41, wherein the energy storage system comprises an adiabatic compressed air energy storage (ACAES) system.

43. A hybrid system according to claim 41, wherein the pre-heater system is configured to supply thermal energy derived from waste heat to the air.

44. A hybrid system according to claim 41, wherein the pre-heater system comprises at least one heat exchanger provided upstream of the first compressor, with respect to the charging mode, and configured in the charging mode to receive heat from at least one further heat exchanger that is located downstream of the first TES system, or a further downstream TES system, with respect to the charging mode.

45. A hybrid system according to claim 44, wherein, in the charging mode, the at least one further heat exchanger is configured to receive heat that has been selectively stored in the first TES system, or further downstream TES system, during the previous discharge generation mode by selective operation of that heat exchanger in that mode.

46. A hybrid system according to claim 45, wherein, during the previous discharge generation mode, the air inlet temperature to the first TES system, or further downstream TES system, is selectively raised by supplying at least some heat to the at least one further heat exchanger from an external source.

47. A hybrid system according to claim 45, wherein, during the previous discharge generation mode, the air inlet temperature to the first TES system, or further downstream TES system, is selectively raised by selecting the degree to which the at least one further heat exchanger discards heat.

48. (canceled)

49. A hybrid combustion turbine power generation system (CTPGS) comprising:
a primary, combustion turbine based system,
the primary system comprising one or more power shaft assemblies comprising at least a first generator or motor/generator, at least a first compressor and at least a first expansion turbine operatively associated with the one or more power shaft assemblies, and at least one combustor configured to feed the at least first expansion turbine,
wherein the primary system comprises a first flow network allowing outlet air from the at least first compressor to pass successively downstream to the at least one combustor for combustion and the at least first expansion turbine for expansion, respectively,
wherein the primary system is modified by integration of:
an adiabatic compressed air energy storage (ACAES) sub-system,
the sub-system comprising at least one compressed air store and at least a first thermal energy storage (TES) system for removing and returning thermal energy to the compressed air upon charging and discharging the store, respectively,
wherein the sub-system comprises a second flow network allowing outlet air from the first compressor to pass, upon charging, via the TES system to the at least one compressed air store, and to pass, upon discharging, back to the at least one combustor and/or first expansion turbine, via the TES system,
wherein the at least one compressed air store is located in the sub-system downstream of at least a second, higher pressure compression/expansion stage of power machinery, and comprises a constant pressure or quasi-constant pressure compressed air store comprising pressure balanced, high pressure pipes, and,
wherein the hybrid CTPGS further comprises flow valve arrangements and mechanical coupling arrangements so configured as to provide the necessary flow and mechanistic connections to allow the hybrid CTPGS to be operable in at least the following modes of operation:—
(i) a power generating first mode in which the hybrid CTPGS produces power and the sub-system is not discharging; and,
(ii) a power generating second mode in which the hybrid CTPGS produces power and the sub-system is discharging.
